(19) United States
(12) Patent Application Publication
(10) Pub. No.: US 2025/0081020 A1
(43) Pub. Date: Mar. 6, 2025

(54) SENSING MODE SWITCHING METHOD AND APPARATUS, AND COMMUNICATION DEVICE

(71) Applicant: VIVO MOBILE COMMUNICATION CO., LTD., Dongguan (CN)

(72) Inventors: Jianzhi LI, Dongguan (CN); Dajie JIANG, Dongguan (CN)

(73) Assignee: VIVO MOBILE COMMUNICATION CO., LTD., Dongguan (CN)

(21) Appl. No.: 18/948,410

(22) Filed: Nov. 14, 2024

Related U.S. Application Data
(63) Continuation of application No. PCT/CN2023/096090, filed on May 24, 2023.

(30) Foreign Application Priority Data
May 30, 2022 (CN) 202210602878.7

(51) Int. Cl. H04W 24/10; H04B 7/06; H04W 4/38

(52) U.S. Cl. CPC H04W 24/10; H04B 7/06968; H04W 4/38

(57) ABSTRACT

A sensing mode switching method and apparatus, and a communication device are provided. The sensing mode switching method includes: obtaining, by a first node, a first sensing measurement result corresponding to each candidate node of N candidate nodes, where the first sensing measurement result includes a result obtained by performing at least one sensing measurement on a sensing target in a first sensing mode through the candidate node, and a signal transmitting node of the first sensing mode and a signal receiving node of the first sensing mode are the same node; and switching, by the first node, a sensing mode of the sensing target from a second sensing mode to the first sensing mode according to the first sensing measurement result corresponding to each candidate node of the N candidate nodes. A signal transmitting node and a signal receiving node of the second sensing mode are different nodes.

### CROSS-REFERENCE TO RELATED APPLICATIONS

This application is a continuation of International Application No. PCT/CN2023/096090, filed May 24, 2023, which claims priority to Chinese Patent Application No. 202210602878.7, filed on May 30, 2022, which is incorporated herein by reference in its entirety.

### TECHNICAL FIELD

This application relates to the technical field of communication, and specifically, to a sensing mode switching method and apparatus, and a communication device.

### BACKGROUND

In some examples, a sensing node in a mobile communication network may achieve sensing measurement of a state or a sensing environment of a sensing target by transmitting and receiving a sensing signal. However, in a case that the state and the sensing environment of the sensing target, a location of the sensing node, an available resource of the sensing node, and the like change, it is often difficult for a current sensing mode to perform accurate sensing measurement on the state or the sensing environment of the sensing target, which results in poor sensing performance.

### SUMMARY

Implementations of the present disclosure provide a sensing mode switching method and apparatus, and a communication device, which can achieve switching of a sensing mode of a sensing target to improve accuracy of a result obtained by performing sensing measurement on the sensing target.

According to a first aspect, a sensing mode switching method is provided, which is applied to a first node. The method includes:
obtaining, by a first node, a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and
switching, by the first node, a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

According to a second aspect, a sensing mode switching apparatus is provided, which is applied to a first node. The apparatus includes:
a first obtaining module, configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and
a first switching module, configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

According to a third aspect, a sensing mode switching method is provided, which is applied to a candidate node. The method includes:
receiving, by a candidate node, first request information from a first node, where the first request information is used to request the candidate node to perform a sensing operation on a sensing target in a first sensing mode, and a signal transmitting node of the first sensing mode and a signal receiving node of the first sensing mode are the same node; and
transmitting, by the candidate node, first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

According to a fourth aspect, a sensing mode switching apparatus is provided, which is applied to a candidate node. The apparatus includes:
a first receiving module, configured to receive first request information from a first node, where the first request information is used to request the candidate node to perform a sensing operation on a sensing target in a first sensing mode, and a signal transmitting node of the first sensing mode and a signal receiving node of the first sensing mode are the same node; and
a first transmitting module, configured to transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

According to a fifth aspect, a sensing mode switching method is provided, which is applied to an eighth node. The method includes:
performing, by an eighth node, a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

According to a sixth aspect, a sensing mode switching apparatus is provided, which is applied to an eighth node. The apparatus includes:
a first execution module, configured to perform a second operation.

The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

According to a seventh aspect, a sensing mode switching method is provided, which is applied to a second node. The method includes:
receiving, by a second node, second request information transmitted by a first node, where the second request information is used to request the second node to search for a candidate node that performs a sensing operation on a sensing target in a first sensing mode, and a signal transmitting node of the first sensing mode and a signal receiving node of the first sensing mode are the same node; and
transmitting, by the second node, second response information corresponding to each candidate node of N candidate nodes to the first node, where the second response information includes second approval information or second rejection information, the second approval information includes a first sensing measurement result corresponding to the candidate node, and N is a positive integer.

According to an eighth aspect, a sensing mode switching apparatus is provided, which is applied to a second node. The apparatus includes:
a first receiving module, configured to receive second request information transmitted by a first node, where the second request information is used to request the second node to search for a candidate node that performs a sensing operation on a sensing target in a first sensing mode, and a signal transmitting node of the first sensing mode and a signal receiving node of the first sensing mode are the same node; and
a first transmitting module, configured to transmit second response information corresponding to each candidate node of N candidate nodes to the first node, where the second response information includes second approval information or second rejection information, the second approval information includes a first sensing measurement result corresponding to the candidate node, and N is a positive integer.

According to a ninth aspect, a terminal is provided. The terminal includes a processor and a memory. The memory stores a program or instructions executable on the processor. The program or the instructions, when executed by the processor, implement steps of the method according to the first aspect, or implement steps of the method according to the third aspect, or implement steps of the method according to the fifth aspect.

According to a tenth aspect, a terminal is provided, including a processor and a communication interface. When the terminal is a first node, the processor is configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and the communication interface is configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

Alternatively, when the terminal is a candidate node, the communication interface is configured to: receive first request information from a first node, where the first request information is used to request the candidate node to perform a sensing operation on the sensing target in the first sensing mode, and a signal transmitting node of the first sensing mode and a signal receiving node of the first sensing mode are the same node; and transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

Alternatively, when the terminal is an eighth node, the communication interface is configured to perform a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

According to an eleventh aspect, a network side device is provided. The network side device includes a processor and a memory. A program or instructions, when executed by the processor, implement steps of the method according to the first aspect, or implement steps of the method according to the third aspect, or implement steps of the method according to the fifth aspect, or implement steps of the method according to the seventh aspect.

According to a twelfth aspect, a network side device is provided, including a processor and a communication interface. When the network side device is a first node, the processor is configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and the communication interface is configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

Alternatively, when the network side device is a candidate node, the communication interface is configured to: receive first request information from a first node, where the first request information is used to request the candidate node to perform a sensing operation on the sensing target in the first sensing mode, and a signal transmitting node of the first sensing mode and a signal receiving node of the first sensing mode are the same node; and transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

Alternatively, when the network side device is an eighth node, the communication interface is configured to perform a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

Alternatively, when the network side device is a second node, the communication interface is configured to: receive second request information transmitted by a first node, where the second request information is used to request a second node to search for a candidate node that performs a sensing operation on a sensing target in a first sensing mode, and a signal transmitting node of the first sensing mode and a signal receiving node of the first sensing mode are the same node; and transmit second response information corresponding to each candidate node of N candidate nodes to the first node, where the second response information includes second approval information or second rejection information, the second approval information includes a first sensing measurement result corresponding to the candidate node, and N is a positive integer.

According to a thirteenth aspect, a sensing mode switching system is provided, including: a first node and a candidate node. The first node may be configured to perform steps of the sensing mode switching method according to the first aspect. The candidate node may be configured to perform steps of the sensing mode switching method according to the third aspect.

According to a fourteenth aspect, a readable storage medium is provided. The readable storage medium stores a program or instructions. The program or the instructions, when executed by a processor, implement steps of the method according to the first aspect, or implement steps of the method according to the third aspect, or implement steps of the method according to the fifth aspect, or implement steps of the method according to the seventh aspect.

According to a fifteenth aspect, a chip is provided. The chip includes a processor and a communication interface. The communication interface is coupled to the processor, and the processor is configured to run a program or instructions to implement steps of the method according to the first aspect, or implement steps of the method according to the third aspect, or implement steps of the method according to the fifth aspect, or implement steps of the method according to the seventh aspect.

According to a sixteenth aspect, a computer program/a program product is provided. The computer program/the program product is stored in a storage medium. The computer program/the program product is executed by at least one processor to implement steps of the method according to the first aspect, or implement steps of the method according to the third aspect, or implement steps of the method according to the fifth aspect, or implement steps of the method according to the seventh aspect.

In the implementations of the present disclosure, a first node obtains a first sensing measurement result corresponding to each candidate node of N candidate nodes, and switches a sensing mode of the sensing target from a second sensing mode to the first sensing mode based on the first sensing measurement result corresponding to each candidate node of the N candidate nodes, so that sensing measurement may be performed on the sensing target more accurately in the switched sensing mode, and the sensing performance of the sensing target is improved.

### BRIEF DESCRIPTION OF THE DRAWINGS

FIG. 1 is a block diagram of a wireless communication system applicable to some implementations of the present disclosure;

FIG. 2a is a schematic diagram of switching a second sensing mode to a first sensing mode provided by some implementations of the present disclosure;

FIG. 2b is a schematic diagram of switching a first sensing mode to a second sensing mode provided by some implementations of the present disclosure;

FIG. 3 is a schematic diagram of different combinations of switching a second sensing mode to a first sensing mode provided by some implementations of the present disclosure;

FIG. 4 is a first flowchart of a sensing mode switching method according to some implementations of the present disclosure;

FIG. 5 is a second flowchart of a sensing mode switching method according to some implementations of the present disclosure;

FIG. 6 is a third flowchart of a sensing mode switching method according to some implementations of the present disclosure;

FIG. 7 is a fourth flowchart of a sensing mode switching method according to some implementations of the present disclosure;

FIG. 8 is a first structural diagram of a sensing mode switching apparatus according to some implementations of the present disclosure;

FIG. 9 is a second structural diagram of a sensing mode switching apparatus according to some implementations of the present disclosure;

FIG. 10 is a third structural diagram of a sensing mode switching apparatus according to some implementations of the present disclosure;

FIG. 11 is a fourth structural diagram of a sensing mode switching apparatus according to some implementations of the present disclosure;

FIG. 12 is a structural diagram of a communication device according to some implementations of the present disclosure;

FIG. 13 is a structural diagram of a terminal according to some implementations of the present disclosure; and

FIG. 14 is a structural diagram of a network side device according to some implementations of the present disclosure.

### DETAILED DESCRIPTION

Technical solutions in implementations of the present disclosure will be clearly and completely described below with reference to accompanying drawings in the implementations of the present disclosure. Apparently, the described implementations are merely part rather than all of the implementations of the present disclosure. All other implementations obtained by those of ordinary skill in the art based on the implementations of the present disclosure fall within the protection scope of the present disclosure.

Terms “first”, “second”, and the like in the specification and claims of the present disclosure are used to distinguish similar objects, but are unnecessarily used to describe a specific sequence or order. It is to be understood that the terms used in this way are exchangeable in a proper case, so that the implementations of the present disclosure can be implemented in an order other than those shown or described herein, and objects distinguished by “first” and “second” are usually of the same category, and the number of the objects is not limited. For example, the first object may be one or multiple. In addition, “and/or” in the specification and the claims represents at least one related connected object, and character “/” generally represents an “or” relationship between associated objects before and after.

It is worth pointing out that, technologies described in the implementations of the present disclosure are not limited to a long term evolution (Long Term Evolution, LTE)/LTE-advanced (LTE-Advanced, LTE-A) system, and may alternatively be applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-Carrier Frequency Division Multiple Access, SC-FDMA), and other systems. Terms “system” and “network” in the implementations of the present disclosure may usually be used interchangeably. The described technologies may be applied the above-mentioned system and radio technology, and may alternatively be applied to other systems and radio systems. The following description describes a new radio (New Radio, NR) system for a purpose of giving examples, and the term NR is used in most of the following descriptions. However, these technologies may alternatively be applied to applications other than an NR system application, for example, a 6th generation (6th Generation, 6G) communication system.

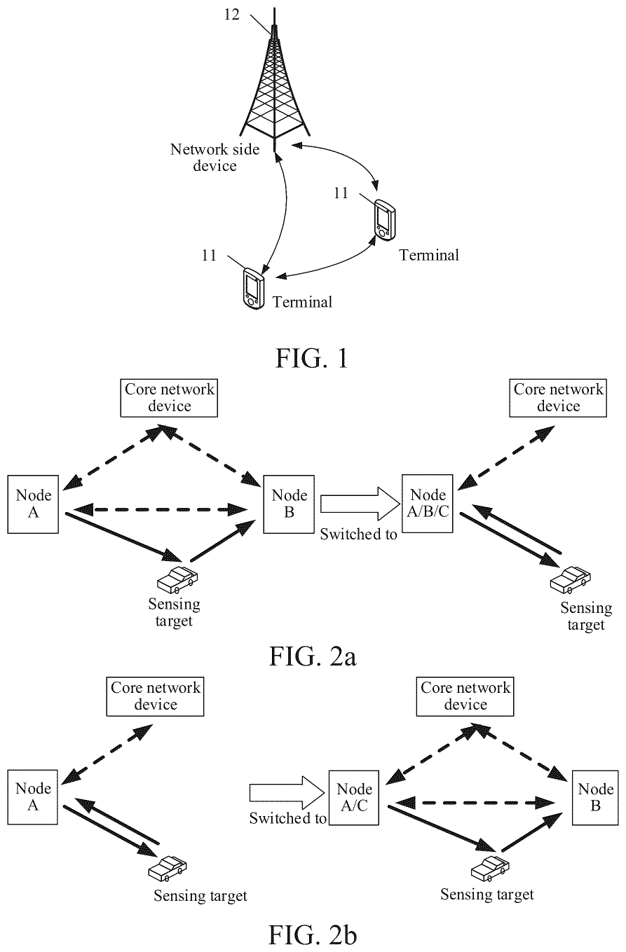

FIG. 1 is a block diagram of a wireless communication system applicable to some implementations of the present disclosure. The wireless communication system includes a terminal 11 and a network side device 12. The terminal 11 may be a terminal side device such as a mobile phone, a tablet personal computer (Tablet Personal Computer), a laptop computer (Laptop Computer) or referred to as a notebook computer, a personal digital assistant (Personal Digital Assistant, PDA), a palm computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), a vehicle user equipment (Vehicle User Equipment, VUE), a pedestrian user equipment (Pedestrian User Equipment, PUE), a smart home device (a home device with a wireless communication function, such as a refrigerator, a television, a washing machine, or furniture), a game console, a personal computer (personal computer, PC), an automatic teller machine, or a self-service machine. The wearable device includes: a smart watch, a smart bracelet, a smart headphone, smart glasses, smart jewelry (a smart bracelet, a smart bracelet, a smart ring, a smart necklace, a smart anklet, a smart ankle chain, and the like), a smart wristband, smart clothing, and the like. It is to be noted that, a specific type of the terminal 11 is not limited in the implementations of the present disclosure. The network side device 12 may include an access network device or a core network device. The access network device may alternatively be referred to as a radio access network device, a radio access network (Radio Access Network, RAN), a radio access network function, or a radio access network unit. The access network device may include a base station, a wireless local area network (Wireless Local Area Network, WLAN) access point (Access Point, AP), a wireless fidelity (Wireless Fidelity, WiFi) node, or the like. The base station may be referred to as a Node B (Node B, NB), an Evolved Node B (Evolved Node B, eNB), an access point, a base transceiver station (Base Transceiver Station, BTS), a radio base station, a radio transceiver, a basic service set (Basic Service Set, BSS), an extended service set (Extended Service Set, ESS), a home Node B (home Node B, HNB), a home evolved node B (home evolved Node B), a transmission reception point (Transmission Reception Point, TRP), or another appropriate term in the art. As long as achieving the same technical effect, the base station is not limited to specific technology vocabulary. It is to be noted that, in the implementations of the present disclosure, an introduction is made by only taking the base station in the NR system as an example, and a specific type of the base station is not limited. The core network device may include, but is not limited to, at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), a unified data management (Unified Data Management, UDM), a unified data repository (Unified Data Repository, UDR), a home subscriber server (Home Subscriber Server, HSS), and a Centralized network configuration (Centralized network configuration, CNC), a network repository function (Network Repository Function, NRF), a network exposure function (Network Exposure Function, NEF), a local NEF (Local NEF, or L-NEF), a binding support function (Binding Support Function, BSF), an application function (Application Function, AF), and the like. It is to be noted that, in the implementations of the present disclosure, an introduction is made by only taking the core network device in the NR system as an example, and a specific type of the core network device is not limited.

To facilitate understanding, some content involved in the implementations of the present disclosure are described below:

First, communication and sensing integration or integrated communication and sensing.

Wireless communication and radar sensing have been developing in parallel, but an intersection of the wireless communication and the radar sensing is limited. The wireless communication and the radar sensing have many commonalities signal processing algorithms, devices, and system architecture to some extent. In recent years, these two systems have attracted more and more attention from researchers in terms of coexistence, collaboration, and joint design.

In early days, people have performed extensive researches on a problem of coexistence of a communication system and a radar system. The researches focused on developing effective interference management technologies to enable two separately deployed systems to operate smoothly without interfering with each other. Although a radar and a communication system may be in the same location or event physically integrated, the radar and the communication system transmit two different signals in a time domain/frequency domain. The radar and the communication system share the same resource through cooperation to reduce the interference with each other when working simultaneously to the greatest extent. Corresponding measures include beamforming, cooperative frequency spectrum sharing, primary and secondary frequency spectrum sharing, dynamic sharing, and the like. However, effective interference cancellation typically requires strict requirements for node mobility and information exchange between nodes. Therefore, the improvement of frequency spectrum efficiency is relatively limited in practice. The interference in a coexistent system is caused by transmitting two independent signals, it is natural to ask whether we can use one transmitting signal for communication and radar sensing simultaneously. Radar systems typically use specially designed waveforms, such as short pulses and chirps, to achieve high-power radiation and simplify receiver processing. However, these waveforms are not necessary for radar detection. A passive radar or passive sensing using different radio signals as sensing signals is a good example.

Machine learning, especially a deep learning technology, further enhances potential of a non-dedicated radio signal for radar sensing. With these technologies, a traditional radar is developing towards a more universal direction of wireless sensing. Wireless sensing here may extensively refer to retrieving information from received radio signals, rather than modulating communication data of the signals at a transmitter. For wireless sensing related to a location of a sensing target, dynamic parameters such as a target signal reflection delay, an angle of arrival (Angle of Arrival, AOA), an angle of departure (Angle of Departure, AOD) and Doppler may be estimated through a commonly used signal processing method. Physical features of the sensing target may be achieved by a measurement device, an object, or an intrinsic mode signal. The two sensing modes may respectively be referred to as sensing parameter estimation and mode recognition. In this sense, wireless sensing refers to a more universal sensing technology and application using radio signals.

Integrated sensing and communication (Integrated Sensing and Communication, ISAC) has a potential to integrate wireless sensing into large-scale mobile network, which is referred to as perceptive mobile networks (Perceptive Mobile Networks, PMNs). A PMN may be evolved from a current 5G mobile network, which is expected to become an ubiquitous wireless sensor network, and simultaneously improves stable and high-quality mobile communication service. The perceptive mobile network may be established on an existing mobile network infrastructure without significantly changing a network structure and device. The perceptive mobile network will release a maximum capacity of a mobile network, and avoid spending high infrastructure cost to additionally and separately construct a new wide area wireless sensor network. With the expansion of coverage, comprehensive communication and a sensing capacity are expected to achieve many new applications. The perceptive mobile network can provide communication and wireless sensing service simultaneously, and may become a ubiquitous wireless sensing solution due to a large broadband coverage and powerful infrastructure. Joint coordination of the communication and the sensing capacity of the perceptive mobile network will improve the productivity of our society and help generate a large number of new applications that cannot be effectively implemented by existing sensor networks. Some early work that performs passive working by using mobile signals has proved the potential of the perceptive mobile network. For example, traffic monitoring, weather forecasting, and rainfall remote sensing based on radio signals of the global system for mobile communications (Global System for Mobile Communications, GSM). The perceptive mobile network may be widely applied to communication and sensing in the fields of traffic, communication, energy, precision agriculture, and security. Existing solutions are either impractical or inefficient. The perceptive mobile network may alternatively provide a complementary sensing capacity for an existing sensor network, has a unique operation function day and night, and can penetrate through fog, leaves, and even solid subjects.

In a mobile communication network, a base station (including one or more TRPs on the base station, a user equipment (User Equipment, UE) (including one or more sub-arrays/panels on the UE)) may serve as a sensing node participating in an ISAC service. A region or an entity target may be sensed by transmitting and receiving a sensing signal between nodes. The sensing signal may be a signal that does not include transmission information, for example, existing LTE/NR synchronization and reference signals, including a synchronization signal and physical broadcast channel (Synchronization Signal and PBCH block, SSB) signal, a channel state information-reference signal (Channel State Information-Reference Signal, CSI-RS), a demodulation reference signal (Demodulation Reference Signal, DMRS), a sounding reference signal (Sounding Reference Signal, SRS), a positioning reference signal (Positioning Reference Signal, PRS), and a phase-tracking reference signal (Phase-tracking reference signal, PTRS), and the like, or may be a continuous wave (Continuous Wave, CW), a frequency modulated continuous wave (Frequency Modulated CW, FMCW), an ultra-wideband Gaussian pulse, and the like commonly used for a radar. The sensing signal may alternatively be a newly designed dedicated sensing signal, which has good correlation property and a low peak to average power ratio (Peak to Average Power Ratio, PAPR), or a newly designed integrated communication and sensing signal, which bears information and has good sensing performance. The following collectively refers to the foregoing sensing signals as a first signal.

Two sensing modes may be classified according to whether the sensing nodes are the same device: A transmitting and B receiving, and A transmitting and receiving. A transmitting and B receiving represents that sensing node A and sensing node B are not the same device, and are separated in physical locations; and A transmitting and receiving represents that a sensing signal is transmitted and received by the same device, and sensing node A senses by receiving a signal echo transmitted by sensing node A. The following collectively refers to the foregoing A transmitting and receiving as first sensing, refers to a corresponding sensing mode as a first sensing mode, refers to the A transmitting and B receiving as second sensing, and refers to a corresponding sensing mode as a second sensing mode.

### Sensing Mode Switching:

a sensing mode is switched in the mobile communication network, including two cases of switching the second sensing mode to the first sensing mode, and switching the first sensing mode to the second sensing mode. FIG. 2a shows a case of switching the second sensing mode to the first sensing mode, and FIG. 2b shows a case of switching the first sensing mode to the second sensing mode. Considering that the sensing node in a network before and after switching may change, and the switched sensing node may be a network side device or a UE, each case of the foregoing two switching cases has six combinations. Taking switching the second sensing mode to the first sensing mode as an example, the combinations specifically include the following:
switching scenario 1: performing a sensing operation by a network side device and a terminal in the second sensing mode is switched to performing a sensing operation by a network side device in the first sensing mode;
switching scenario 2: performing a sensing operation by a network side device and a network side device in the second sensing mode is switched to performing a sensing operation by a network side device in the first sensing mode;
switching scenario 3: performing a sensing operation by a network side device and a terminal in the second sensing mode is switched to performing a sensing operation by a terminal in the first sensing mode;
switching scenario 4: performing a sensing operation by a terminal and a terminal in the second sensing mode is switched to performing a sensing operation by a terminal in the first sensing mode;
switching scenario 5: performing a sensing operation by a terminal and a terminal in the second sensing mode is switched to performing a sensing operation by a network side device in the first sensing mode; and
switching scenario 6: performing a sensing operation by a network side device and a network side device in the second sensing mode is switched to performing a sensing operation by a terminal in the first sensing mode.

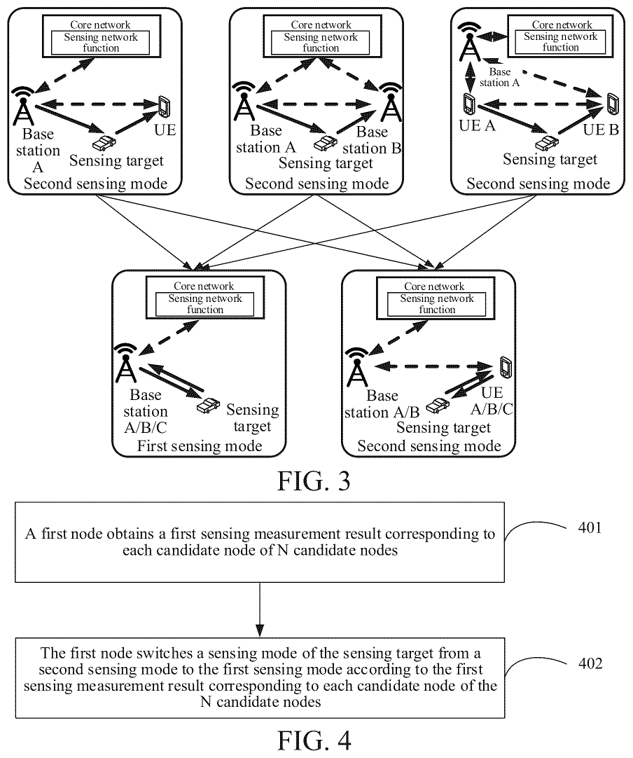

FIG. 3 shows a schematic diagram of different combinations of switching a second sensing mode to a first sensing mode. Based on a network side device, to express that sensing nodes may be different devices, base station A, base station B, base station C, UE A, UE B, and UE C are configured to distinguish.

A sensing mode switching method according to the implementations of the present disclosure is described in detail below through some implementations and application scenarios of the implementations with reference to accompanying drawings.

Refer to FIG. 4, which is a flowchart of a sensing mode switching method according to some implementations of the present disclosure. The method may be performed by a first node, as shown in FIG. 4, including the following steps:

Step 401: A first node obtains a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer.

In this implementation, the signal transmitting node of the foregoing first sensing mode and the signal receiving node of the foregoing first sensing mode are the same node. For example, sensing node C transmits a first signal, and receives the first signal reflected by the sensing target to achieve sensing measurement. The foregoing sensing node may include a terminal or a network side device (for example, a base station). Correspondingly, a signal transmitting node of a second sensing mode and a signal receiving node of a second sensing mode are different nodes. For example, sensing node A transmits the first signal, and sensing node B receives the first signal reflected by the sensing target to achieve sensing measurement.

The foregoing first node may include a first network side device, a second network side device, a first terminal, a core network device, or the like. The foregoing first network side device may be a network side device accessed by a terminal that performs the sensing operation on the sensing target in the second sensing mode before the sensing mode is switched. The foregoing second network side device may be a network side device that performs the sensing operation on the sensing target in the second sensing mode before the sensing mode is switched. The foregoing first terminal may be a terminal that performs the sensing operation on the sensing target in the second sensing mode before the sensing mode is switched. The foregoing core network device may include, for example, a sensing function (Sensing Function, SF), an access and mobility management function (Access and Mobility Management Function, AMF), or a sensing application server in a core network.

The foregoing candidate node may include a terminal or a network side device. It is to be noted that, the foregoing N candidate nodes may include a second network side device or a first terminal, or not include a second network side device or a first terminal. This is not specifically limited in this implementation.

The foregoing first sensing measurement result may include at least one of a measurement value of a sensing measurement quantity and a sensing result. In some example implementations, the foregoing sensing measurement quantity may include, but is not limited to, at least one of the following:
a first level measurement quantity, where the first level measurement quantity may include a received signal/channel response complex result, an amplitude/phase, In-phase path/Quadrature path, and operation results thereof (operations including addition, subtraction, multiplication, and division, matrix addition, subtraction, and multiplication, matrix transposition, triangular relation operation, square root operation, power operation, and the like, and threshold detection results, maximum/minimum value extraction results, and the like of the foregoing operation results; the operations further include fast Fourier transform (Fast Fourier Transform, FFT)/inverse fast Fourier transform (Inverse Fast Fourier Transform, IFFT), discrete Fourier transform (Discrete Fourier Transform, DFT)/inverse discrete Fourier transform (Inverse Discrete Fourier Transform, IDFT), 2-dimensional FFT (2D-FFT), 3-dimensional FFT (3D-FFT), matched filtering, an autocorrelation operation, wavelet transform, digital filtering, and the like, and threshold detection results, maximum/minimum value extraction results, and the like of the foregoing operation results);
a second level measurement quantity, where the second level measurement quantity (a basic measurement quantity) includes a delay, Doppler, an angle, strength, and multidimensional combination representations thereof;
a third level measurement quantity (a basic attribute/state), where the third level measurement quantity includes: at least one of a distance, a velocity, an orientation, a spatial position, and an acceleration; and
a fourth level measurement quantity (an advanced attribute/state), where the fourth level measurement quantity includes: at least one of existence of a sensing target, a trajectory, an action, an expression, a vital sign, a quantity, an imaging result, weather, air quality, a shape, a material, and a composition.

For example, the sensing measurement quantity further includes corresponding label information, for example, may include at one of the following: sensing signal identification information, sensing measurement configuration identification information, sensing service information (for example, a sensing service ID), a data subscription ID, a measurement quantity purpose (for example, communication, sensing, communication and sensing), time information, sensing node information (for example, a terminal ID, a node location, and a device orientation), sensing link information (for example, a sensing link number and a transceiver node), a measurement quantity description information (forms, for example, an amplitude value, a phase value, and a complex value combining an amplitude and a phase; a resource type, for example, a time domain measurement result, and a frequency domain resource measurement result), and measurement quantity indicator information (for example, a signal noise ratio (Signal Noise Ratio, SNR), and a sensing SNR).

The foregoing sensing result may be a sensing result determined based on a measurement value of the sensing measurement quantity, may be a final sensing result, or may be an intermediate sensing result for calculating a final sensing result.

Step 402: The first node switches a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

For example, the first node may select at least one target node from the N candidate nodes according to the first sensing measurement result corresponding to the N candidate nodes, and transmit switching confirmation information to the at least one target node to switch the sensing mode of the sensing target from the second sensing mode to the first sensing mode.

According to the sensing mode switching method according to the implementations of the present disclosure, the first node obtains the first sensing measurement result corresponding to each candidate node of N candidate nodes, and switches the sensing mode of the sensing target from the second sensing mode to the first sensing mode based on the first sensing measurement result corresponding to each candidate node of the N candidate nodes, so that the sensing mode of the sensing target can be switched in a case that a state of the sensing target, a sensing environment, a location of a sensing node, an available resource of the sensing node, and the like change, and sensing measurement may be performed on the sensing target more accurately in the switched sensing mode, thereby improving the accuracy of a result obtained by performing sensing measurement on the sensing target.

For example, the first node obtains the first sensing measurement result corresponding to each candidate node of N candidate nodes. Obtaining the first sensing measurement result corresponding to each candidate node of N candidate nodes includes:
the first node obtains a switching measurement report; and
the first node obtains the first sensing measurement result corresponding to each candidate node of the N candidate nodes according to the switching measurement report.

In this implementation, the foregoing switching measurement report may include, but is not limited to, one or more of a measurement value of at least one sensing measurement quantity, a measurement value of at least one sensing performance evaluation indicator, a measurement value of at least one communication measurement quantity, a measurement value of at least one communication performance evaluation indicator, and the like.

The foregoing first node obtains the first sensing measurement result corresponding to each candidate node of the N candidate nodes according to the switching measurement report. For example, in a case that the switching of the sensing mode of the sensing target from the second sensing mode to the first sensing mode is determined to be initiated according to the switching measurement report, the first sensing measurement result corresponding to each candidate node of the N candidate nodes is obtained, and otherwise, the first sensing measurement result corresponding to each candidate node of the N candidate nodes may not be obtained.

In some example implementations, the foregoing first node may determine whether to initiate the switching of the sensing mode of the sensing target from the second sensing mode to the first sensing mode according to the switching measurement report. For example, in a case that the foregoing measurement value of the at least one sensing measurement quantity satisfies a first threshold condition or the foregoing measurement value of the at least one sensing performance evaluation indicator satisfies a second threshold condition, the switching of the sensing mode of the sensing target from the second sensing mode to the first sensing mode is determined to be initiated, otherwise, the switching of the sensing mode of the sensing target from the second sensing mode to the first sensing mode is not initiated. In a case that the switching of the sensing mode of the sensing target from the second sensing mode to the first sensing mode is determined to be initiated, the first sensing measurement result corresponding to each candidate node of the N candidate nodes is obtained.

In this implementation, the first sensing measurement result corresponding to each candidate node of the N candidate nodes is obtained according to the switching measurement report, whether the first sensing measurement result corresponding to each candidate node of the N candidate nodes needs to be obtained may be determined more accurately, thereby ensuring the accuracy of the sensing operation of the sensing target while reducing unnecessary switching.

For example, that the first node obtains the switching measurement report includes:
the first node performs switching measurement to obtain the switching measurement report, where the first node is the signal receiving node that performs a sensing operation on the sensing target in the second sensing mode.

Alternatively,
the first node receives the switching measurement report, where the first node includes a core network device or a source transmitting node or a first network side device, the source transmitting node is the signal transmitting node that performs a sensing operation on the sensing target in the second sensing mode, and the first network side device is a network side device accessed by the terminal that performs a sensing operation on the sensing target in the second sensing mode.

In some implementations, in a case that the first node is the signal receiving node that performs a sensing operation on the sensing target in the second sensing mode, the first node may perform switching measurement to obtain the switching measurement report. It is to be noted that, in this case, the first node may spontaneously perform switching measurement, and may perform switching measurement in a case that a switching measurement request is received.

In another embodiment, in a case that the first node is a core network device or a source transmitting node or a first network side device, the first node may receive the switching measurement report. For example, in a case that the first node is a core network device, the first node may receive the foregoing switching measurement report from a source receiving node (a signal receiving node that performs the sensing operation on the sensing target in the second sensing mode), a source transmitting node, or a first network side device; in a case that the foregoing first node is a source transmitting node, the first node may receive the foregoing switching measurement report from a source receiving node, or a core network device, or a first network side device; and in a case that the first node is a first network side device, the first node may receive the foregoing switching measurement report from a source receiving node, or a core network device, or a source transmitting node.

For example, a trigger condition for the first node to perform switching measurement includes at least one of the following:
a state of the sensing target changes;
a location of the terminal that performs the sensing operation on the sensing target in the second sensing mode changes;
a sensing region environment of the sensing target changes;
a sensing measurement quantity obtained by the first node satisfies a first condition;
a communication measurement quantity obtained by the first node satisfies a second condition; and
an available sensing resource of at least one node that performs a sensing operation on the sensing target in the second sensing mode changes.

The state of the foregoing sensing target changes, for example, a location, a velocity, and the like of the foregoing sensing target change.

The sensing region environment of the sensing target changes, for example, an obstruction appears in a sensing region of the foregoing sensing target.

The sensing measurement quantity obtained by the foregoing first node satisfies the first condition, for example, at least one of a sensing signal received power, a signal noise ratio (Signal Noise Ratio, SNR), a signal to interference plus noise ratio (Signal to Interference Plus Noise Ratio, SINR), a distance measurement value, a velocity measurement value, an angle measurement value, and the like is less than or equal to a corresponding first preset threshold.

The communication measurement quantity obtained by the foregoing first node satisfies the second condition, for example, at least one of a reference signal received power (Reference Signal Received Power, RSRP), the SNR, the SINR, a reference signal received quality (Reference Signal Received Quality, RSRQ), a received signal strength indicator (Received Signal Strength Indicator, RSSI), and the like is less than or equal to a corresponding second preset threshold, and/or, at least one of a symbol error rate, a block error rate, throughput, spectrum efficiency, and the like is greater than or equal to a corresponding third preset threshold.

The foregoing available sensing resource of at least one node that performs a sensing operation on the sensing target in the second sensing mode changes, for example, other high-priority sensing services, communication services, or integrated communication and sensing services burst, and whether to initiate a sensing switching process needs to be evaluated based on remaining available sensing resource.

For example, the switching measurement report may include at least one of the following:
a measurement value of at least one sensing measurement quantity;
a measurement value of at least one sensing performance evaluation indicator;
a measurement value of at least one communication measurement quantity;
a measurement value of at least one communication performance evaluation indicator;
indication information used to indicate whether a preset event occurs, where the preset event is used to trigger initiation of switching the sensing mode of the sensing target from the second sensing mode to the first sensing mode; and
indication information used to indicate whether a preset switching condition is satisfied, where the preset switching condition is used to trigger initiation of switching the sensing mode of the sensing target from the second sensing mode to the first sensing mode.

In this implementation, for the foregoing sensing measurement quantity, refer to related description described above. Details are not described herein again.

The foregoing sensing performance evaluation indicator may be calculated based on the sensing measurement quantity. In some example implementations, the sensing performance evaluation indicator may include at least one of the following:
a sensing SNR, which represents a ratio of energy of a sensing signal reflected by a sensing target or a sensing region to energy of a noise signal in an environment and a device;
a sensing SINR, which represents a ratio of energy of a sensing signal reflected by a sensing target or a sensing region to a sum of energy of a noise signal and energy of a noise signal in an environment and a device;
a statistical mean, a standard deviation, or a variance of multiple measurement values of the same sensing measurement quantity;
a deviation between the measurement value of the sensing measurement quantity or a predicted value and an actual measurement value of a sensing result, and a statistical mean, a standard deviation, or a variance of the deviation; and
a sum of sensing reproducible evaluation indicators (for example, the Euclidean Distance between two sequence sampling points before and after), or a warped path distance in dynamic time warping (Dynamic Time Warping, DTW), or other indicators that can reflect the similarity between two sequences. The indicators that can reflect the similarity between two sequences include, but are not limited to: a longest common subsequence (Longest Common Subsequence, LCSS), an edit distance on real sequences (Edit Distance on Real Sequences, EDR), an edit distance with real penalty (Edit Distance with Real Penalty, ERP), a Hausdorff distance (Hausdorff Distance), a Fréchet distance (Fréchet Distance), a one way distance (One Way Distance, OWD), a locality in-between polylines (Locality In-between Polylines, LIP), and the like.

The foregoing communication measurement quantity may include at least one of the following: RSRP, an SNR, an SINR, reference signal received quality (Reference Signal Received Quality, RSRQ), a received signal strength indicator (Received Signal Strength Indicator, RSSI), a symbol error rate, a block error rate, throughput, spectrum efficiency, and the like.

In some example implementations, the foregoing communication performance evaluation indicator may be calculated based on the foregoing communication measurement quantity.

In some example implementations, the switching measurement report at least includes a measurement value of a sensing measurement quantity required for sensing measurement. The sensing measurement quantity required for sensing measurement may include a sensing measurement quantity of a current sensing service.

For example, before the first node performs switching measurement to obtain the switching measurement report, the method further includes:
the first node receives at least one of a switching measurement request and switching measurement configuration information;
or
before the first node receives the switching measurement report, the method further includes:
the first node transmits a switching measurement request.

In some implementations, in a case that the first node is a source receiving node, the first node may receive at least one of the switching measurement request and the switching measurement configuration information, and performs switching measurement based on at least one of the switching measurement request and the switching measurement configuration information. For example, the first node may receive at least one of the switching measurement request and the switching measurement configuration information from a core network device, or a source transmitting node, or a source access network device. It is to be noted that, the foregoing switching measurement request and the switching measurement configuration information may be transmitted through the same message, or may be transmitted through different messages. In addition, the foregoing switching measurement request and the switching measurement configuration information may from the same device, or from different devices. This is not limited in this implementation.

In some example implementations, before the foregoing first node performs switching measurement to obtain the switching measurement report, the switching measurement request may be received. The switching measurement request includes switching measurement configuration information.

For example, the switching measurement configuration information may include at least one of the following: measurement object indication information, a switching measurement report configuration, measurement event configuration information, and a measurement identifier, where one measurement identifier corresponds to each of one measurement object and one switching measurement report configuration.

In this implementation, the foregoing measurement object indication information may be used to indicate information such as one or more first signals of a source node and/or a candidate node that needs to be measured, and a sensing measurement quantity, sensing parameter configuration information, and the like related to the first signal.

The foregoing switching measurement report configuration may include at least one of the following: a reporting principle, for example, a periodicity reporting or event triggering principle; and a measurement report format, for example, a maximum quantity of reported cells and a quantity of beams.

The foregoing measurement event configuration information may include at least one of a measurement event definition, event related parameters, a switching determination condition, and the like.

For example, that the first node obtains a first sensing measurement result corresponding to each candidate node of N candidate nodes includes:
the first node transmits first request information to each candidate node of M candidate nodes, where the first request information is used to request the candidate node to perform a sensing operation on the sensing target in the first sensing mode, and M is a positive integer; and
the first node receives first approval information corresponding to each candidate node of the N candidate nodes, where the N candidate nodes are N candidate nodes of the M candidate nodes, N is less than or equal to M, and the first approval information includes the first sensing measurement result corresponding to the candidate node.

In this implementation, in a case that the first node is a core network device, the foregoing M candidate nodes may include a second network side device or a first terminal, or may not include a second network side device or a first terminal. In a case that the first node is a second network side device or a first terminal, the foregoing M candidate nodes do not include a second network side device or a first terminal.

It is to be noted that, the foregoing candidate node, after receiving the first request information, may transmit the foregoing first approval information or first rejection information in response to the first request information, where the foregoing first approval information is used to indicate the first node that a transmitting party of the first approval information agrees to perform a sensing operation on the sensing target in the first sensing mode after the sensing mode is switched, and the first rejection information is used to indicate the first node that a transmitting party of the first rejection information rejects to perform a sensing operation on the sensing target in the first sensing mode. The foregoing N candidate nodes may be N candidate nodes of the M candidate nodes that feed the first approval information back.

For example, the first request information includes at least one of the following:
first configuration information, where the first configuration information is used for sensing parameter configuration for the candidate node to perform the sensing operation in the first sensing mode;
a sensing demand;
sensing quality of service (Quality of Service, QoS);
a sensing measurement quantity;
a sensing measurement result;
a sensing condition;
priori information of the sensing target;
priori information of a sensing region of the sensing target; and
a sensing mode switching success determination condition.

In this implementation, the foregoing first configuration information may be configuration information recommended by the first node. For example, the first configuration information may include at least one of the following: sensing parameter configuration information, and soft switching parameter configuration information. The foregoing sensing parameter configuration information is used for parameter configuration for the candidate node to perform the sensing operation on the sensing target in the first sensing mode. The foregoing soft switching parameter configuration information is configured to switch the sensing mode of the sensing target from the second sensing mode to the first sensing mode.

For example, the sensing parameter configuration information may include at least one of the following: a waveform type, a subcarrier spacing, a guard interval, a bandwidth, data burst duration, a time domain interval, signal transmitted power, a signal format, a signal direction, a time resource, a frequency resource, a quasi-co-location (Quasi-Co-Location, QCL) relationship, and antenna configuration information.

In this implementation, the foregoing waveform type is, for example, orthogonal frequency division multiplexing (Orthogonal Frequency Division Multiplexing, OFDM), single carrier frequency division multiple access (Single Carrier Frequency Division Multiple Access, SC-FDMA), orthogonal time frequency space (Orthogonal Time Frequency Space, OTFS), a frequency-modulated continuous wave (Frequency-Modulated Continuous Wave, FMCW), a pulse signal, and the like.

The foregoing subcarrier spacing is, for example, a subcarrier spacing 30 KHz of an OFDM system.

The foregoing guard interval is, for example, a time interval from a time when transmission of a signal is ended to a time when a latest echo signal of the signal is received. This parameter is directly proportional to a maximum sensing distance. For example, the foregoing guard interval may be calculated through 2dₘₐₓ/c, dₘₐₓ is the maximum sensing distance (belonging to the sensing demand), for example, for a sensing signal received spontaneously, dₘₐₓ represents a maximum distance from a sensing signal transceiving point to a signal transmitting point. In some cases, an OFDM signal cyclic prefix (Cyclic prefix, CP) may play a role of a minimum guard interval.

The foregoing bandwidth may be inversely proportional to a distance resolution, and may be obtained through c/(2Δd), where Δd is the distance resolution (belonging to the sensing demand); and c is a light velocity.

The foregoing data burst duration may be inversely proportional to a velocity resolution (belonging to the sensing demand). This parameter is a time span of the sensing signal, which is mainly used to calculate a Doppler frequency offset. This parameter may be calculated through c/(2f_{c}Δv), where Δv is the velocity resolution; and f_{c} is a carrier frequency of the sensing signal.

The foregoing time domain interval may be calculated through c/(2f_{c}v_{range}), where v_{range} is a maximum rate minus a minimum velocity (belonging to a sensing demand); and this parameter is a time interval between two adjacent sensing signals.

It is to be understood that, the foregoing “/” indicates a division sign in above formulas.

The foregoing signal transmitted power, for example, takes a value every 2 dBm from −20 dBm to 23 dBm.

The foregoing signal format is, for example, an SRS, a DMRS, and a PRS, or other pre-defined signals, and related information such as sequence format.

The foregoing signal direction is, for example, a direction or beam information of the sensing signal.

The foregoing time resource is, for example, a slot index where the sensing signal is located or a symbol index of a slot. There are two types of time resources. One is a disposable time resource, for example, one symbol transmits an omnidirectional sensing signal. The other is a non-disposable time resource, for example, multiple groups of periodic time resources or discontinuous time resources (which may include a starting time and an ending time). Each group of periodic time resources transmit sensing signals in the same direction, and beam directions of different groups of periodic time resources are different.

The foregoing frequency resource is, for example, a center frequency point of the sensing signal, a bandwidth, an RB or a subcarrier, reference point A (Point A), and an initial bandwidth location.

The foregoing QCL relationship is that, for example, the sensing signal includes multiple resources. Each resource and one synchronization signal and PBCH block (Synchronization Signal and PBCH block, SSB) are in QCL. The QCL includes type A (Type A), Type B, Type C, or Type D.

The foregoing antenna configuration information may include at least one of the following:
an antenna array element ID or an antenna port ID used to transmit and/or receive the sensing signal;
a panel ID and an array element ID used to transmit and/or receive the sensing signal;
location information (which may be represented by Cartesian coordinates (x, y, z) or spherical coordinates) of an antenna array element used to transmit and/or receive the sensing signal relative to a local reference point on an antenna array;
location information (which may be represented by Cartesian coordinates (x, y, z) or spherical coordinates) of a panel used to transmit and/or receive the sensing signal relative to a local reference point on an antenna array, and location information (which may be represented by Cartesian coordinates (x, y, z) or spherical coordinates) of antenna array elements in these selected panels used to transmit the sensing signal relative to a unified reference point of the panel (for example, a panel central point);
bitmap information of an antenna array element, for example: the bitmap using “1” to indicate that an array element is selected to transmit and/or receive a sensing signal, and using “O” to indicate that an array element is not selected (or vice versa); and
bitmap information of the array panel and bitmap information of the array element in the selected panel, for example: the bitmap of the array panel using “1” to indicate that an array element is selected to transmit and/or receive a sensing signal, and using “O” to indicate that an array element is not selected (or vice versa).

The foregoing sensing demand may include at least one of a sensing target region, a sensing target type, a required sensing function, a sensing purpose, a sensing result, and the like.

The foregoing sensing QoS may include at least one of the following:
a sensing resolution, for example, a ranging resolution, an angle measurement resolution, a velocity measurement resolution, and an imaging resolution;
sensing accuracy, for example, ranging accuracy, angle measurement accuracy, velocity measurement accuracy, and positioning accuracy;
a sensing range, for example, a ranging range, a velocity measurement range, an angle measurement range, and an imaging range;
a sensing delay, for example, a time interval from transmitting a sensing signal to obtaining a sensing result, alternatively, a time interval from initiating a sensing demand to obtaining a sensing result;
a sensing updating rate, for example, a time interval between two adjacent executions of sensing and obtaining the sensing results;
detection probability, for example, probability that a sensing target is correctly detected in a case that the sensing target exists;
false alarm probability, for example, probability that a sensing target is incorrectly detected in a case that the sensing target does not exist;
sensing security; and
sensing privacy.

For the foregoing sensing measurement quantity, refer to related description described above. Details are not described herein again. The foregoing sensing measurement result may include a sensing result directly or indirectly obtained based on at least one sensing measurement quantity.

The foregoing sensing condition may include at least one of a sensing starting time, a sensing ending time, sensing duration, and the like.

The foregoing priori information of the sensing target may include at least one of a sensing target type, a sensing target historical state (for example, a velocity, an angle, a distance, an acceleration, a spatial orientation), and the like.

The foregoing priori information of a sensing region of the sensing target may include information of an approximate location or region where the sensing target is located.

The foregoing sensing mode switching success determination condition indicates that, for example, a measurement value of at least one sensing measurement quantity and/or communication measurement quantity reaches a corresponding preset threshold within a preset time or preset number of times.

For example, the first approval information further includes second configuration information, where the second configuration information is used for sensing parameter configuration for the candidate node to perform the sensing operation in the first sensing mode.

In this implementation, the foregoing second configuration information may be configuration information recommended by the candidate node. For example, the second configuration information may include at least one of the following: sensing parameter configuration information, and soft switching parameter configuration information.

It is to be noted that, when performing sensing parameter configuration for the sensing operation according to the first sensing mode, the candidate node may perform configuration based on at least one of the foregoing first configuration information and the foregoing second configuration information, or may perform configuration based on configuration information different from both the foregoing first configuration information and the foregoing second configuration information. This is not limited in this implementation.

For example, the M candidate nodes are determined based on first information of the M candidate nodes, where the first information includes at least one of the following:
location information;
panel orientation information;
sensing capacity information;
current available resource information for sensing; and
channel state information.

The foregoing sensing capacity information of the candidate node includes, for example, at least one of a sensing coverage, a maximum bandwidth available for sensing, maximum duration of a sensing service, a supportable sensing signal type and frame format, antenna array information (an array type, a quantity of antennas, an array aperture, an antenna polarization characteristic, an array element gain, a directivity characteristic, and the like).

The foregoing current available resource information for sensing of the candidate node includes, for example, at least one of a time resource (a quantity of symbols, a quantity of slots, a quantity of frames, and the like), a frequency resource (a quantity of resource blocks (Resource Blocks, RBs), a quantity of resource elements (Resource Elements, REs), a total bandwidth, an available frequency band location, and the like), an antenna resource (a quantity of antennas/antenna subarrays), a phase modulation resource (a quantity of hardware phase shifters), an orthogonal code resource (lengths and a quantity of orthogonal codes), and the like.

The foregoing channel state information of the candidate node may include, for example, at least one of a channel transmission function/channel impulse response, a channel quantity indicator (Channel Quality Indicator, CQI), a precoding matrix indicator (Precoding Matrix Indicator, PMI), a CSI-RS resource indicator, an SSB resource indicator, a layer indicator (Layer Indicator, LI), a rank indicator (Rank indicator, RI), an L1-reference signal received power (L1-Reference Signal Received Power, L1-RSRP), and the like of at least one communication link.

It is to be noted that, the foregoing candidate node may include a candidate network side device or a candidate terminal. The first node may determine M candidate network side devices based on first information of each network side device, or the first node may determine M candidate terminals based on first information of each terminal.

For example, that the first node obtains a first sensing measurement result corresponding to each candidate node of N candidate nodes includes:
the first node transmits second request information to a second node, where the second request information is used to request the second node to search for a candidate node that performs a sensing operation on the sensing target in the first sensing mode; and
the first node receives second approval information corresponding to each candidate node of the N candidate nodes from the second node, where the second approval information includes the first sensing measurement result corresponding to the candidate node.

The candidate node in this implementation may be a terminal.

In some example implementations, in a case that the first node is a core network device, the foregoing second node may include a first network side device, a second network side device, or a third network side device. In a case that the first node is a first network side device, the foregoing second node may include a second network side device or a third network side device. In a case that the first node is a second network side device, the foregoing second node may include a first network side device or a third network side device. The foregoing first network side device may be a network side device accessed by a terminal that performs a sensing operation on the sensing target in the second sensing mode before the sensing mode is switched, the foregoing second network side device may be a network side device that performs a sensing operation on the sensing target in the second sensing mode before the sensing mode is switched, and the foregoing third network side device is a network side device accessed by the candidate node.

Specifically, after the first node transmits second request information to the second node, the second node may obtain third response information corresponding to each candidate node of K candidate nodes, and determine and transmit second approval information corresponding to the N candidate nodes to the first node based on the third response information corresponding to each candidate node of the K candidate nodes, where K may be greater than or equal to N.

For example, the first node is a sensing node that performs a sensing operation on the sensing target in the second sensing mode, and the N candidate nodes include the first node; and
that the first node obtains a first sensing measurement result corresponding to each candidate node of N candidate nodes includes:
the first node performs at least one sensing measurement on the sensing target in the first sensing mode to obtain a first sensing measurement result corresponding to the first node.

In this implementation, in a case that the first node is a candidate node, the first node may perform at least one sensing measurement on the sensing target in the first sensing mode to obtain the first sensing measurement result corresponding to the first node. For example, the first node may perform sensing parameter configuration related to the first sensing mode based on the first configuration information, and perform at least one sensing measurement on the sensing target in the first sensing mode to obtain the first sensing measurement result corresponding to the first node.

It is to be noted that, in a case that N is 1, the first sensing measurement result corresponding to the foregoing N candidate nodes is a first sensing measurement result corresponding to the foregoing first node. In a case that N is greater than 1, that the first node obtains a first sensing measurement result corresponding to each candidate node of N candidate nodes may further include:
the first node transmits first request information to each candidate node of P candidate nodes, where the first request information is used to request the candidate node to perform a sensing operation on the sensing target in the first sensing mode, and P is a positive integer;
the first node receives first approval information corresponding to each candidate node of N−1 candidate nodes, where the N−1 candidate nodes are N−1 candidate nodes of the P candidate nodes, N−1 is less than or equal to P, and the first approval information includes the first sensing measurement result corresponding to the candidate node.

For example, the method further includes:
the first node transmits first indication information to a third node, where
the first indication information is used to indicate a network side device to perform a sensing operation on the sensing target in the first sensing mode after the sensing mode is switched, one of the first node and the third node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

For example, the method further includes:
the first node transmits second indication information to a fourth node, where
the second indication information is used to indicate the fourth node to perform sensing on the sensing target after the sensing mode is switched, the first node includes a core network device or a first network side device or a second network side device, the first network side device is a network side device accessed by a terminal that performs the sensing operation on the sensing target in the second sensing mode, the second network side device is a network side device that performs the sensing operation on the sensing target in the second sensing mode, and the fourth node is a sensing node that performs the sensing operation on the sensing target in the second sensing mode.

It may be understood that, in a case that the first node is a second network side device, the fourth node is a sensing node that is different from the second network side device and that is of the sensing nodes that perform the sensing operation on the sensing target in the second sensing mode.

For example, the method further includes:
the first node transmits third indication information to a fifth node, where the third indication information is used to indicate a transmitting party of the third indication information to perform a sensing operation on the sensing target in the first sensing mode after the sensing mode is switched, the first node is a first sensing node that performs the sensing operation on the sensing target in the second sensing mode, and the fifth node includes at least one of a core network device and a second sensing node that performs the sensing operation on the sensing target in the second sensing mode;
or
the first node receives third indication information from a fifth node, where the third indication information is used to indicate a transmitting party of the third indication information to perform a sensing operation on the sensing target in the first sensing mode after the sensing mode is switched, the first node includes at least one of a first sensing node that performs the sensing operation on the sensing target in the second sensing mode and a core network device, and the fifth node is a second sensing node that performs the sensing operation on the sensing target in the second sensing mode.

In this implementation, the foregoing first sensing node and second sensing node are two different sensing nodes that perform the sensing operation on the sensing target in the second sensing mode before the sensing mode is switched.

For example, the method further includes:
the first node transmits fourth indication information to a sixth node, where
the fourth indication information is used to indicate a terminal to perform a sensing operation on the sensing target in the first sensing mode after the sensing mode is switched, one of the first node and the sixth node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

For example, that the first node switches a sensing mode of the sensing target from a second sensing mode to the first sensing mode according to the first sensing measurement result corresponding to each candidate node of the N candidate nodes includes:
the first node transmits switching confirmation information to at least one target node, where the target node is a candidate node of the N candidate nodes corresponding to the first sensing measurement result satisfying a first switching condition, and the switching confirmation information is used to notify the target node to perform the sensing operation on the sensing target in the first sensing mode.

In this implementation, the first node may determine at least one target node according to the first sensing measurement result corresponding to the N candidate nodes, and then may transmit the switching confirmation information to the at least one target node to notify the target node to perform the sensing operation on the sensing target in the first sensing mode after the sensing mode is switched. The target node is the candidate node of the N candidate nodes corresponding to the first sensing measurement result satisfying the first switching condition.

For example, the first switching condition includes at least one of the following:
a measurement value of at least one sensing measurement quantity in the first sensing measurement result within a first time period is greater than or equal to a first preset threshold, alternatively, a number of times that a measurement value of at least one sensing measurement quantity in the first sensing measurement result within a first time period is greater than or equal to a first preset threshold reaches a first preset number of times;
a measurement value of at least one sensing measurement quantity in the first sensing measurement result within a second time period is greater than a measurement value of a sensing measurement quantity corresponding to a second sensing measurement result, alternatively, a number of times that a measurement value of at least one sensing measurement quantity in the first sensing measurement result within a second time period is greater than a measurement value of a sensing measurement quantity corresponding to a second sensing measurement result reaches a second preset number of times, and the second sensing measurement result is the first sensing measurement result obtained by performing the sensing operation in the second sensing mode within the first time period;
at least one sensing performance evaluation indicator in the first sensing measurement result within a third time period is greater than or equal to a second preset threshold, alternatively, a number of times that at least one sensing performance evaluation indicator in the first sensing measurement result within a third time period is greater than or equal to a second preset threshold reaches a third preset number of times;
at least one sensing performance evaluation indicator in the first sensing measurement result within a fourth time period is greater than a sensing performance evaluation indicator corresponding to a second sensing measurement result, alternatively, a number of times that at least one sensing performance evaluation indicator in the first sensing measurement result within a fourth time period is greater than a sensing performance evaluation indicator corresponding to a second sensing measurement result within a fourth time period reaches a fourth preset number of times;
a first target value within a first time period is greater than or equal to a first preset threshold, alternatively, a number of times that a first target value within a first time period is greater than a first preset threshold reaches a first preset number of times, and the first target value includes a measurement value of at least one sensing measurement quantity in the first sensing measurement result and a measurement value of at least one communication measurement quantity corresponding to the candidate node;
a second target value within a third time period is greater than or equal to a second preset threshold, alternatively, a number of times that a second target value within a third time period is greater than or equal to a second preset threshold exceeds a third preset number of times, and the second target value includes at least one sensing performance evaluation indicator in the first sensing measurement result and a measurement value of at least one communication measurement quantity corresponding to the candidate node; and
the first sensing measurement result within a fourth time period is superior to the second sensing measurement result.

The sensing performance evaluation indicator in this implementation may be calculated based on the sensing measurement quantity. For the sensing measurement quantity and the sensing performance evaluation indicator in this implementation, refer to related description described above. Details are not described herein again.

It is to be noted that, in some implementations, switching is confirmed to be triggered when satisfying at least one of the following: a location of a terminal that performs the sensing operation on the sensing target in the second sensing mode changes before switching; and a traditional switching event is satisfied.

A configuration of the traditional switching event is:
event A1: quality of a service cell is higher than a threshold;
event A2: quality of a service cell is lower than a threshold;
event A3: quality of a neighboring cell is an offset value higher than that of a service cell;
event A4: quality of a neighboring cell is higher than a threshold;
event A5: quality of a service cell is lower than a threshold 1, and quality of a neighboring cell is higher than threshold 2;
event A6: quality of a neighboring cell is higher than that of an auxiliary cell;
event B1: quality of an inter-radio access technology (Inter-Radio Access Technology, Inter-RAT) neighboring cell is higher than a threshold;
event B2: quality of a main cell is lower than a threshold 1, and quality of an Inter-RAT neighboring cell is higher than a threshold 2; and
event I1: interference quality is higher than a threshold.

In this implementation, the first node transmits switching confirmation information to corresponding at least one target node with the first sensing measurement result satisfying a first switching condition, which can ensure good sensing performance of a sensing node after a sensing mode is switched, and then the sensing performance after switching can be further improved.

For example, the at least one target node includes a target terminal; and
that the first node transmits switching confirmation information to at least one target node includes:
the first node transmits switching confirmation information to the target terminal through a third network side device, where the third network side device is an access network device of the target terminal.

In this implementation, in a case that the target node is a target terminal, the first node may transmit the switching confirmation information to the third network side device. The third network side device forwards the received switching confirmation information to the target terminal.

For example, the method further includes at least one of the following:
the first node transmits a sensing end command to a seventh node, where the sensing end command is used to indicate a receiving party of the sensing end command to end the sensing operation on the sensing target in the second sensing mode, the seventh node is a sensing node that performs the sensing operation on the sensing target in the second sensing mode, and the seventh node is different from the at least one target node; and
the first node transmits switching canceling information to a first candidate node, where the switching canceling information is used to notify the first candidate node to cancel the sensing operation performed on the sensing target in the first sensing mode and release a reserved sensing resource, and the first candidate node includes a candidate node other than the at least one target node of the N candidate nodes.

In some example implementations, in a case that the foregoing seventh node is a terminal, the first node may directly transmit the sensing end command to the seventh node, or may transmit the sensing end command to the seventh node through a first network side device, where the first network side device is a network side device accessed by the seventh node.

In some example implementations, in a case that the candidate node is a terminal, the first node may directly transmit the switching canceling information to the first candidate node, or may transmit the switching canceling information to the first candidate node through a third network side device, where the foregoing third network side device is a network device accessed by the foregoing first candidate node.

For example, the method further includes:
the first node ends performing the sensing operation on the sensing target in the second sensing mode, and releases the resource occupied by performing sensing on the sensing target, where the first node is a sensing node that performs the sensing operation on the sensing target in the second sensing mode.

It may be understood that, in this implementation, the foregoing first node is a sensing node that performs the sensing operation on the sensing target in the second sensing mode before the sensing mode is switched, and the first node is not the target node.

For example, the method further includes:
the first node transmits sensing reference information to the at least one target node, where the sensing reference information includes at least one of the following:
a historical measurement value of a sensing measurement quantity of the sensing target;
a historical sensing result of the sensing target;
priori information of the sensing target; and
priori information of a sensing region where the sensing target is located.

In this implementation, the sensing measurement quantity in the sensing reference information before the sensing mode is switched may be the same as or different from the sensing measurement quantity after the sensing mode is switched. After the target node is determined, the first node transmits first information to the target node to assist the target node in performing a sensing operation on the sensing target, so that the sensing performance can be further improved.

For example, the method further includes:
in a case that the first node does not obtain the first sensing measurement result corresponding to the candidate node within a second preset time, or the first sensing measurement results corresponding to the N candidate nodes do not satisfy a first switching condition, the first node performs a first operation.

The first operation includes one of the following: redetermining the candidate node, canceling switching the sensing mode of the sensing target from the second sensing mode to the first sensing mode, and ending performing a sensing operation on the sensing target in the second sensing mode.

For example, in a case that rejection information corresponding to the candidate node is received by the first node within the second preset time, or the obtained first sensing measurement results corresponding to the candidate nodes do not satisfy a first switching condition, a candidate node may be redetermined and first request information may be transmitted to the redetermined candidate node, or the switching the sensing mode of the sensing target from the second sensing mode to the first sensing mode may be canceled, or performing a sensing operation on the sensing target in the second sensing mode may be ended.

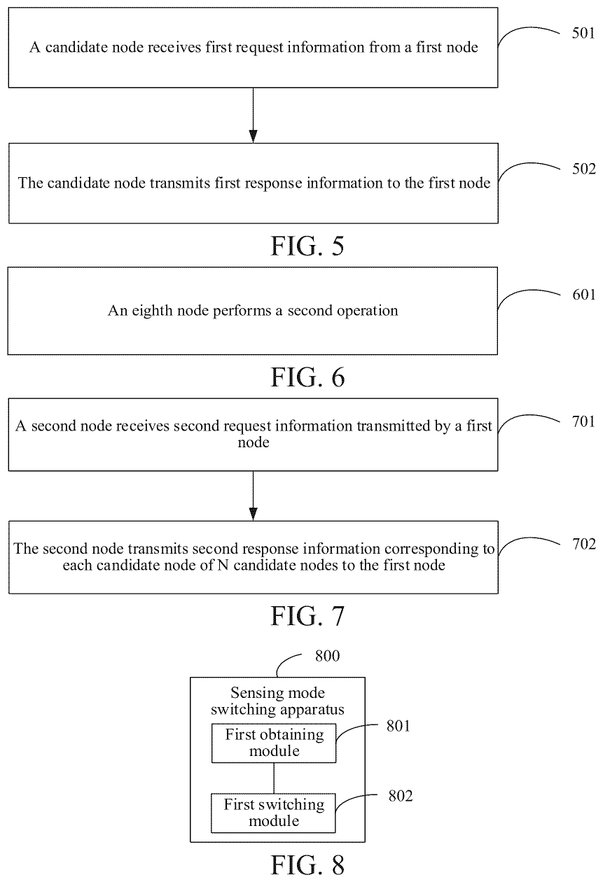

Refer to FIG. 5, which is a flowchart of a sensing mode switching method according to some implementations of the present disclosure. This method may be performed by a candidate node, as shown in FIG. 5, including the following steps:

Step 501: A candidate node receives first request information from a first node, where the first request information is used to request the candidate node to perform a sensing operation on a sensing target in a first sensing mode, and a signal transmitting node of the first sensing mode and a signal receiving node of the first sensing mode are the same node.

In this implementation, the foregoing candidate node may include a candidate terminal or a candidate network side device.

Step 502: The candidate node transmits first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

In this implementation, after receiving the first request information from the first node, the foregoing candidate node may perform, in response to the first request information, at least one sensing measurement quantity on the sensing target in the first sensing mode to obtain the first sensing measurement result, and transmit first approval information carrying the first sensing measurement result to the first node. Alternatively, after receiving the first request information from the first node, the foregoing candidate node may perform, in response to the first request information, first rejection information to the first node.

For example, before the candidate node transmits first response information to the first node, the method further includes:
the candidate node performs sensing parameter configuration related to the first sensing mode according to the first request information; and
the candidate node performs at least one sensing measurement on the sensing target in the first sensing mode to obtain a first sensing measurement result.

For example, the first request information includes at least one of the following:
first configuration information, where the first configuration information is used for sensing parameter configuration for the candidate node to perform the sensing operation in the first sensing mode;
a sensing demand;
sensing quality of service QoS;
a sensing measurement quantity;
a sensing measurement result;
a sensing condition;
priori information of the sensing target or priori information of a sensing region where the sensing target is located; and
a sensing mode switching success determination condition.

For example, the first configuration information includes at least one of the following: sensing parameter configuration information, and soft switching parameter configuration information.

For example, the sensing parameter configuration information includes at least one of the following: a waveform type, a subcarrier spacing, a guard interval, a bandwidth, data burst duration, a time domain interval, signal transmitted power, a signal format, a signal direction, a time resource, a frequency resource, a quasi-co-location QCL relationship, and antenna configuration information.

For example, the first approval information further includes second configuration information, where the second configuration information is used for sensing parameter configuration for the candidate node to perform the sensing operation in the first sensing mode.

For example, the method further includes:
the candidate node receives switching confirmation information from the first node, where the switching confirmation information is used to notify the candidate node to perform the sensing operation on the sensing target in the first sensing mode after the sensing mode of the sensing target is switched;
alternatively,
the candidate node receives switching canceling information from the first node, where the switching canceling information is used to notify the candidate node to cancel performing the sensing operation on the first sensing target in the first sensing mode and release a reserved sensing resource.

In this implementation, in a case that the candidate node is the target node (for example, the first sensing measurement result corresponding to the candidate node satisfies a first switching condition), the candidate node may receive switching confirmation information from the first node.

In a case that the candidate node is the first candidate node (for example, the first sensing measurement result corresponding to the candidate node satisfies a first switching condition), the candidate node may receive switching canceling information from the first node.

For example, after the candidate node receives the switching confirmation information from the first node, the method further includes:
the candidate node performs sensing parameter configuration related to the first sensing mode according to at least one of the first request information and the second configuration information; and
the candidate node performs the sensing operation on the sensing target in the first sensing mode.

For example, after the candidate node receives the switching confirmation information from the first node, the method further includes:
the candidate node receives sensing reference information from the first node, where the sensing reference information includes at least one of the following:
a historical measurement value of a sensing measurement quantity of the sensing target;
a historical sensing result of the sensing target;
priori information of the sensing target; and
priori information of a sensing region where the sensing target is located.

For example, the candidate node is a sensing node that performs the sensing operation on the sensing target in a second sensing mode, and a signal transmitting node of the second sensing mode and the signal receiving node of the second sensing mode are different nodes. The method further includes:
the candidate node receives a sensing end command from the first node; and
the candidate node ends performing the sensing operation on the sensing target in the second sensing mode, and releases a resource occupied by performing sensing on the sensing target.

It is to be noted that, for some content involved in this implementation, refer to related description of the implementations described above. Details are not described herein again.

Refer to FIG. 6, which is a flowchart of a sensing mode switching method according to some implementations of the present disclosure. The method may be performed by an eighth node, as shown in FIG. 6, including the following steps:

Step 601: An eighth node performs a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

In this implementation, the eighth node may include a first network side device, or a second network side device, or a first terminal. The foregoing first network side device may be a network side device accessed by a terminal that performs a sensing operation on the sensing target in the second sensing mode before the sensing mode is switched, the foregoing second network side device may be a network side device that performs a sensing operation on the sensing target in the second sensing mode before the sensing mode is switched, and the foregoing first terminal may be a terminal that performs a sensing operation on the sensing target in the second sensing mode before the sensing mode is switched.

For example, the eighth node is the signal receiving node that performs the sensing operation on the sensing target in the second sensing mode.

Before transmitting the switching measurement report, the method further includes:
the eighth node receives second information, where the second information includes at least one of a switching measurement request and switching measurement configuration information; and
the eighth node performs switching measurement according to the second information to obtain the switching measurement report.

For example, the switching measurement request includes the switching measurement configuration information.

For example, the switching measurement configuration information includes at least one of the following: measurement object indication information, a switching measurement report configuration, measurement event configuration information, and a measurement identifier, where one measurement identifier corresponds to each of one measurement object and one switching measurement report configuration.

For example, sensing nodes that perform the sensing operation on the sensing target in the second sensing mode before the sensing mode is switched include the eighth node and a ninth node.

A triggering condition for the eighth node to perform switching measurement includes at least one of the following:
a state of the sensing target changes;
a sensing region environment of the sensing target changes;
a sensing measurement quantity obtained by the eighth node satisfies a first condition;
a communication measurement quantity obtained by the eighth node satisfies a second condition;
a location of at least one node of the eighth node and the ninth node changes, and at least one of the eighth node and the ninth node is a terminal;
a distance between the eighth node and the ninth node changes, and at least one of the eighth node and the ninth node is a terminal;
a communication measurement quantity between the eighth node and a network side device accessed by the eighth node satisfies a third condition, and the eighth node is a terminal;
a communication measurement quantity between the ninth node and a network side device accessed by the ninth node satisfies a third condition, and the ninth node is a terminal; and
an available sensing resource of at least one of the eighth node and the ninth node changes.

In this implementation, the communication measurement quantity between the eighth node and the network side device accessed by the eighth node satisfies a third condition or the communication measurement quantity between the ninth node and the network side device accessed by the ninth node satisfies a third condition, for example, at least one of the RSRP, the SNR, the SINR, the RSRQ, the RSSI, and the like is less than or equal to a corresponding second preset threshold, and/or, at least one of a symbol error rate, a block error rate, throughput, spectrum efficiency, and the like is greater than or equal to a corresponding third preset threshold.

For example, after receiving the sensing end command, the method further includes:
the eighth node ends performing the sensing operation on the sensing target in the second sensing mode, and releases a resource occupied by performing sensing on the sensing target.

The eighth node in this implementation is a sensing node that performs the sensing operation on the sensing target in the second sensing mode before the sensing mode is switched.

It is to be noted that, for some content involved in this implementation, refer to related description of the implementations described above. Details are not described herein again.

Refer to FIG. 7, which is a flowchart of a sensing mode switching method according to some implementations of the present disclosure. The method may be performed by the second node, as shown in FIG. 7, including the following steps:

Step 701: A second node receives second request information transmitted by a first node, where the second request information is used to request the second node to search for a candidate node that performs a sensing operation on a sensing target in a first sensing mode, and a signal transmitting node of the first sensing mode and a signal receiving node of the first sensing mode are the same node.

Step 702: The second node transmits second response information corresponding to each candidate node of N candidate nodes to the first node, where the second response information includes second approval information or second rejection information, the second approval information includes a first sensing measurement result corresponding to the candidate node, and N is a positive integer.

In some example implementations, the foregoing N candidate nodes may be N terminals managed by the foregoing second node.

For example, before the second node transmits the second response information corresponding to each candidate node of N candidate nodes to the first node, the method further includes:
the second node transmits third request information to at least one candidate node, where the third request information is used to request the candidate node to perform the sensing operation on the sensing target in the first sensing mode; and
the second node receives third response information corresponding to each candidate node of K candidate nodes, where the third response information includes third approval information or third rejection information, the third approval information includes a first sensing measurement result corresponding to the candidate node, the second response information corresponding to the N candidate nodes includes part or all of the third response information corresponding to the K candidate nodes, and K is a positive integer greater than or equal to N.

It is to be noted that, the third request information in this implementation may be the same as or different from the first request information in the implementations described above. The third response information in this implementation may be the same as or different from the first response information in the implementations described above.

In some example implementations, the foregoing at least one candidate node may be at least one terminal managed by the foregoing second node.

The second response information corresponding to the foregoing N candidate nodes may be determined based on the third response information corresponding to the foregoing K candidate nodes. For example, the second node may select and transmit the third response information corresponding to the N candidate nodes from the K candidate nodes to the first node. The foregoing second response information is the same as the foregoing third response information. Alternatively, the second node may select the third response information corresponding to the N candidate nodes the foregoing K candidate nodes, and the second response information corresponding to each candidate node may be determined according to the third response information corresponding to each candidate node and transmitted to the first node.

For example, the at least one candidate node is determined based on first information of the at least one candidate node, where the first information includes at least one of the following:
location information;
panel orientation information;
sensing capacity information;
current available resource information for sensing; and
channel state information.

It is to be noted that, for some content involved in this implementation, refer to related description of the implementations described above. Details are not described herein again.

To better understand the present disclosure, the following describes in detail based on different switching scenarios, performing a sensing operation in a first sensing mode is referred to as first sensing, and performing a sensing operation in a second sensing mode is referred to as second sensing.

Switching scenario 1: Performing a sensing operation by a network side device and a terminal in the second sensing mode is switched to performing a sensing operation by a network side device in the first sensing mode, that is, base station-UE second sensing is switched to the first sensing of a base station, where the base station that performs the second sensing before switching is referred to as a source base station, and then the base station that performs the first sensing before switching is referred to as a target base station. A UE in this switching scenario is the UE that performs the second sensing before switching.

Step 11: Switching measurement is performed, including two cases of downlink sensing (that is, the source base station transmits a signal, and a source terminal receives the signal) and uplink sensing (that is, the source terminal transmits the signal, and the source base station receives the signal):

### (1) Base Station-UE is the Downlink Sensing:

The source base station transmits a switching measurement request to the UE, and the UE performs switching measurement after receiving the switching measurement request and feeds back a switching measurement report to the source base station.

Alternatively,
the core network device (for example, a sensing function network element) transmits a switching measurement request to the UE, and the UE performs switching measurement after receiving the switching measurement request and feeds back a switching measurement report to the core network device. In some example implementations, the UE or the core network device transmits the switching measurement report to the source base station.

In some example implementations, before the UE performs switching measurement, the core network device or the source base station transmits switching measurement configuration information required by the switching measurement to the UE, alternatively, the switching measurement configuration information is included in the switching measurement request.

### (2) Base Station-UE is the Uplink Sensing:

The source base station performs switching measurement. In some example implementations, before the source base station performs switching measurement, the core network device or the UE transmits the switching measurement request to the source base station.

In some example implementations, before the source base station performs switching measurement, the core network device or the UE transmits switching measurement configuration information required by the switching measurement to the source base station, alternatively, the switching measurement configuration information is included in the switching measurement request.

For the switching measurement configuration information, refer to related description in the implementations described above. Details are not described herein again.

For example, the foregoing step 11 may be triggered based on a triggering event. For the triggering event of the foregoing step 11, refer to related description in the implementations described above. Details are not described herein again.

Step 12: The source base station determines whether to initiate switching based on the switching measurement report.

For example, the source base station reports the switching measurement report to the core network device, and the core network device determines whether to initiate a switching request, alternatively, the core network device determines whether to initiate a switching request according to the switching measurement report received from the UE.

In a case that switching is not initiated, subsequent processing may be maintaining or ending current second sensing.

In a case that switching is initiated, the core network device or the source base station determines which node is switched to the first sensing mode, specifically including one of the following cases:

Case 1: The source base station determines to switch to the base station to perform the first sensing.

The source base station transmits first request information to at least one candidate base station. The first request information requests a first request information receiving party to perform the second sensing after the sensing mode is switched.

For example, the source base station transmits first indication information to the core network device. The first indication information notifies the first indication information receiving party to perform the first sensing after the sensing mode is switched.

For example, the source base station transmits second indication information to the UE. The second indication information indicates the second indication information receiving party not to participate in sensing after the sensing mode is switched.

Case 2: The core network device determines to switch to the base station to perform the first sensing.

The core network device transmits first request information to at least one candidate base station.

For example, the core network device transmits the first indication information to the source base station.

For example, the core network device transmits second indication information to the UE.

For example, the candidate base station includes a source base station.

Case 3: The source base station determines to be actively switched to perform the first sensing. In this case, the source base station is a candidate base station.

The source base station transmits third indication information to the core network device. The third indication information indicates a third indication information receiving party that a third indication information transmitting party may perform the first sensing after the sensing mode is switched.

For example, case 3 further includes case 1.

For example, the source base station or the core network device includes recommended first configuration information in the first request information. The first configuration information includes sensing parameter configuration information, which is used for the candidate base station and a target base station to perform sensing parameter configuration of the first sensing.

For example, the first request information may include a soft switching request. For example, the first configuration information may further include soft switching parameter configuration information.

For the foregoing first request information and first configuration information, refer to related description in the implementations described above. Details are not described herein again.

In some example implementations, the foregoing base station may be determined based on the candidate base station. For the first information, refer to related description in the implementations described above. Details are not described herein again.

Step 13: The candidate base station determines whether to perform the first sensing after the sensing mode is switched. Specifically, there are several cases as follows:

Case one: In a case that the candidate base station agrees, the following processes are performed in sequence:
(13-1) The candidate base station may perform sensing parameter configuration based on at least one of the first request information and the first configuration information, and perform the first sensing.
(13-2) After performing at least one sensing measurement, the candidate base station transmits first approval information to the source base station or the core network device. The first approval information indicates a first request information transmitting party that a first approval information transmitting party agrees to perform the first sensing after the sensing mode is switched.

Content of the first approval information includes a first sensing measurement result. The first sensing measurement result may include at least one of the following:
(1) a measurement value of at least one sensing measurement quantity that performs the first sensing and/or a sensing result;
(2) a measurement result of at least one sensing performance evaluation indicator; and
(3) a measurement value of a communication measurement quantity.

For the foregoing sensing measurement quantity, the sensing performance evaluation indicator, and the communication measurement quantity, refer to related description in the implementations described above. Details are not described herein again.

For example, the first approval information may further include:

second configuration information. The second configuration information is used for sensing parameter configuration for the target base station to perform the first sensing.

For the foregoing second configuration information, refer to related description in the implementations described above. Details are not described herein again.

For example, in a case that the first request information includes a soft switching request, and the candidate base station agrees and supports soft switching, the foregoing second configuration information may further include soft switching parameter configuration information.
(3-3) The source base station or the core network device waits for first approval information of the candidate base station within a second preset time. Once receiving that the first approval information transmitted by a candidate base station satisfies a first switching condition, the candidate base station is immediately selected as a sensing node that performs the first sensing after switching, that is, a target node.

For the foregoing first switching condition, refer to related description in the implementations described above. Details are not described herein again.

Case two: In a case that the candidate base station disagrees, for example, the candidate base station transmits first rejection information to the first request information transmitting party (the source base station or the core network device). The first rejection information indicates the first request information transmitting party that the first rejection information transmitting party not to perform the first sensing.

In a case that there is no candidate base station agrees to perform the first sensing within the second preset time, subsequent processing may be one of the following: i. the source base station or the core network device redetermines the candidate base station; ii. switching is canceled, and current second sensing is maintained; and iii. the current second sensing is ended.

Step 14: The source base station or the core network device transmits, after determining a target base station, switching confirmation information to the target base station. The switching confirmation information is used to notify a switching confirmation information receiving party to perform a first sensing operation subsequently.

For example, the source base station or the core network device transmits, after determining a target base station, switching canceling information to another candidate base station other than the target base station. The switching canceling information is used to notify another candidate sensing node to cancel performing the first sensing and release a reserved sensing resource. The another candidate base station releases the reserved sensing resource after receiving the switching canceling information.

Step 15: The target base station performs a sensing service, and the UE releases a sensing resource. Specifically, the following operations are performed:
(15-1) The target base station performs sensing parameter configuration based on at least one of the first request information, the first configuration information, and the second configuration information, and performs the first sensing.
(15-2) The UE or the UE and source base station stop performing the second sensing, and release the sensing resource. According to different sensing nodes before and after switching, one of the following cases is included:
(1) The first request information transmitting party is the source base station, and the source base station and the target base station are not the same device.

The source base station transmits a sensing end command to the UE. The source base station and the UE end an original sensing operation, and release a resource occupied by sensing (including a time-frequency resource, an antenna port resource, and the like).

For example, the source base station transmits historical measurement values and/or historical sensing results of part or all sensing measurement quantities, and priori information of a sensing target/region to the target base station.
(2) The first request information transmitting party is the core network device, and the source base station and the target base station are not the same device.

The core network device transmits a sensing end command to the source base station and the UE. The source base station and the UE end an original sensing operation, and release a resource occupied by sensing (including a time-frequency resource, an antenna port resource, and the like).

For example, the core network device transmits historical measurement values and/or historical sensing results of part or all sensing measurement quantities, and priori information of a sensing target/region to the target base station.
(3) The first request information transmitting party is the core network device, and the source base station and the target base station are the same device.

The core network device transmits the sensing end command to the UE. The UE ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target base station.
(15-3) After obtaining a measurement result and/or a sensing result of at least one sensing measurement quantity, the target base station transmits the measurement result and/or the sensing result of the sensing measurement quantity to the source base station or the core network device.

It is to be noted that, in this switching scenario, the sensing measurement quantity before the sensing mode is switched may be the same as or different from the sensing measurement quantity after the sensing mode is switched.

Switching scenario 2: Performing a sensing operation by a network side device and a network side device in a second sensing mode is switched to performing a sensing operation by a network side device in a first sensing mode, that is, base station-base station second sensing is switched to base station first sensing. Base station A and base station B perform second sensing before the sensing mode is switched, a base station that transmits a sensing signal is base station A, and a base station that receives the sensing signal is base station B. Base stations A and B that perform the second sensing before switching are referred to as source base stations, and a base station that performs the first sensing after switching is referred to as a target base station.

Step 21: Switching measurement is performed. Base station A transmits a switching measurement request to base station B. Base station B performs switching measurement after receiving the switching measurement request, and feeds back a switching measurement report to base station A. For example, Base station A or base station B transmits the switching measurement report to the core network device.

Alternatively,

the core network device (for example, the sensing function network element) transmits a switching measurement request to base station B. The base station B performs switching measurement after receiving the switching measurement request, and feeds back the switching measurement report to the core network device. For example, base station B or the core network device transmits the switching measurement report to base station A.

Alternatively, base station B actively performs switching measurement to obtain the switching measurement report. For example, base station B transmits the switching measurement report to the core network device or base station A.

For example, before base station B performs switching measurement, base station A or the core network device transmits switching measurement configuration information required for switching measurement; alternatively, the switching measurement configuration information is included in the switching measurement request.

For the switching measurement configuration information, refer to related description in the implementations described above. Details are not described herein again.

For example, the foregoing step 21 may be triggered based on a triggering event. For the triggering event of the foregoing step 21, refer to related description in the implementations described above. Details are not described herein again.

Step 2: base station A determines whether to initiate switching based on the switching measurement report.

For example, base station A or base station B reports the switching measurement report to the core network device, and the core network device determines whether to initiate a switching request.

In a case that switching is not initiated, subsequent processing may be maintaining or ending current second sensing.

In a case that switching is initiated, the core network device or the source base stations (including base station A and base station B) determine which node is switched to the first sensing mode, specifically including one of the following cases:

Case 1: Base station A determines to switch to the base station to perform the first sensing. Base station A transmits first request information to at least one candidate base station.

For example, base station A transmits first indication information to the core network device.

For example, the candidate base station includes base station B.

Case 2: Base station B determines to switch to the base station to perform the first sensing. Base station B transmits first request information to at least one candidate base station.

For example, base station B transmits first indication information to the core network device.

The candidate base station includes base station A.

Case 3: The core network device determines to switch to the base station to perform the first sensing mode. The core network device transmits first request information to at least one candidate base station.

For example, the core network device transmits first indication information to base station A and/or base station B.

For example, the candidate base station includes at least one of base station A and base station B.

Case 4: Base station A determines to be actively switched to perform the first sensing. Base station A transmits third indication information to base station B and/or the core network device. In this case, base station A is a candidate base station.

For example, case 4 may further include case 1.

Case 5: Base station B determines to be actively switched to perform the first sensing. Base station B transmits third indication information to base station A and/or the core network device. In this case, base station B is a candidate base station.

For example, case 5 may further include case 2.

For example, the source base station or the core network device includes recommended first configuration information in the first request information.

For example, the first request information may include a soft switching request. For example, the first configuration information may further include soft switching parameter configuration information.

Step 3: The candidate base station determines whether to perform the first sensing after the sensing mode is switched.

Case one: In a case that the candidate base station agrees, the following processes are performed in sequence:
(23-1) The candidate base station performs sensing parameter configuration based on the first request information, and performs the first sensing.
(23-2) After performing at least one sensing measurement, the candidate base station transmits first approval information to the source base station or the core network device.

For the first approval information, refer to related description in the implementations described above. Details are not described herein again.
(23-3) The source base station or the core network device waits for the first approval information of the candidate base station within a second preset time. Once receiving that the first approval information transmitted by a candidate base station satisfies a first switching condition, the candidate base station is immediately selected as a sensing node that performs the first sensing after switching.

For example, the first approval information may further include:

second configuration information. The second configuration information is used for sensing parameter configuration for the target base station to perform the first sensing.

For the foregoing second configuration information, refer to related description in the implementations described above. Details are not described herein again.

For example, in a case that the first request information includes a soft switching request, and the candidate base station agrees and supports soft switching, the foregoing second configuration information may further include soft switching parameter configuration information.

Case two: In a case that the candidate base station disagrees, for example, the candidate base station transmits first rejection information to the first request information transmitting party (the source base station or the core network device).

In a case that there is no candidate base station agrees to perform the first sensing within the second preset time, subsequent processing may be one of the following: i. the source base station or the core network device redetermines the candidate base station; ii. switching is canceled, and current second sensing is maintained; and iii. the current second sensing is ended.

Step 24: This step is the same as the foregoing step 14. Details are not described herein again.

Step 25: The target base station performs a sensing service, and at least one source base station (base station A and/or base station B) releases a sensing resource. Specifically, the following operations are performed:
(25-1) The target base station performs sensing parameter configuration based on at least one of the first request information, the first configuration information, and the second configuration information, and performs the first sensing.
(25-2) The source base station (base station A and/or base station B) stops performing the second sensing, and releases the sensing resource. According to different sensing nodes before and after switching, one of the following cases is included:
(1) The first request information transmitting party is base station A, and base station A and the target base station are not the same device:
base station A transmits a sensing end command to base station B. Base station A and base station B end an original sensing operation, and release a resource occupied by sensing (including a time-frequency resource, an antenna port resource, and the like).
For example, base station A transmits historical measurement values and/or historical sensing results of part or all sensing measurement quantities, and priori information of a sensing target/region to the target base station.
(2) The first request information transmitting party is the core network device, and the source base station and the target base station are not the same device.

The core network device transmits a sensing end command to base station A and base station B. Base station A and base station B end an original sensing operation, and release a resource occupied by sensing (including a time-frequency resource, an antenna port resource, and the like).

For example, the core network device transmits historical measurement values and/or historical sensing results of part or all sensing measurement quantities, and priori information of a sensing target/region to the target base station.
(3) The first request information transmitting party is the core network device, and base station A and the target base station are the same device.

The core network device transmits a sensing end command to base station B. Base station B ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target base station.
(4) The first request information transmitting party is the core network device, and base station B and the target base station are the same device.

The core network device transmits a sensing end command to base station A. Base station A ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target base station.
(25-3) After obtaining a measurement result and/or a sensing result of at least one sensing measurement quantity, the target base station transmits the measurement result and/or the sensing result of the sensing measurement quantity to the source base station or the core network device.

It is to be noted that, in this switching scenario, the sensing measurement quantity before the sensing mode is switched may be the same as or different from the sensing measurement quantity after the sensing mode is switched.

Switching scenario 3: performing a sensing operation by a network side device and a terminal in the second sensing mode is switched to performing a sensing operation by a terminal in the first sensing mode, that is, base station-UE second sensing is switched to UE first sensing. The base station and the UE perform the second sensing before the sensing mode is switched, the UE that performs the second sensing before switching is referred to as a source UE, and the UE that performs the first sensing after switching is referred to as a target UE. The base station that performs the second sensing before switching is referred to as a source base station, and the base station accessed by the target UE is referred to as a target base station.

Step 31: This step is the same as the foregoing step 11. Details are not described herein again.

Step 32: The source base station determines whether to initiate switching based on the switching measurement report.

Alternatively, the source base station reports the switching measurement report to the core network device, and the core network device determines whether to initiate a switching request.

Alternatively, the core network device determines whether to initiate a switching request according to the switching measurement report received from the source UE.

In a case that switching is not initiated, subsequent processing may be maintaining or ending current second sensing.

In a case that switching is initiated, the core network device or the source base station determines which node is switched to the first sensing mode, specifically including one of the following two cases:

Case 1: The source base station determines to switch to the UE to perform the first sensing.

The source base station transmits first request information to at least one candidate UE. Alternatively, the source base station transmits second request information to at least one candidate access base station. The second request information requests a second request information receiving party (that is, the candidate access base station) to search for the candidate UE, and performs the second sensing after the sensing mode is switched. Further, the candidate access base station transmits the first request information to at least one candidate UE.

For example, the source base station transmits fourth indication information to the core network device. The fourth indication information notifies a fourth indication information receiving party to perform the first sensing after the sensing mode is switched.

For example, the candidate UE includes the source UE.

Case 2: The core network device determines to switch to the UE to perform the first sensing mode.

The core network device transmits first request information to at least one candidate UE. Alternatively, the core network device transmits second request information to at least one candidate access base station, and the candidate access base station transmits the first request information to the at least one candidate UE.

For example, the core network device transmits second indication information to the source base station and/or the source UE.

For example, the candidate access base station includes the source base station.

Case 3: The source UE determines to be actively switched to perform the first sensing. In this case, the source UE is a candidate UE.

The source UE transmits third indication information to the source base station and/or the core network device.

For example, case 3 may further include case 1.

For example, the source base station or the core network device includes recommended first configuration information in the first request information and the second request information.

For example, the first request information and the second request information may include a soft switching request.

The foregoing candidate UE may be determined based on the first information of the candidate UE. For the first information, refer to related description in the implementations described above. Details are not described herein again.

For the foregoing first request information, refer to related description in the implementations described above. Details are not described herein again.

Step 33: The candidate UE determines whether to perform the first sensing after the sensing mode is switched.

Case one: In a case that the candidate UE agrees, the following processes are performed in sequence:
(33-1) The candidate UE performs sensing parameter configuration based on at least one of the first request information and the first configuration information, and performs the first sensing.
(33-2) After performing at least one sensing measurement, the candidate UE transmits first approval information to the source base station or the candidate access base station.

For content of the first approval information, refer to related description in the implementations described above. Details are not described herein again.

For example, the candidate access base station transmits second approval information to a second request information transmitting party (the source base station or the core network device). The second approval information indicates the second request information transmitting party that the UE accessed by this cell agrees to perform the first sensing after the sensing mode is switched.

For example, the second approval information includes part or all content of the first approval information.

For example, the candidate UE feeds back recommended first configuration information in the first approval information.

For the foregoing first configuration information, refer to related description in the implementations described above. Details are not described herein again.

In a case that the first request information and the second request information include a soft switching request, and the candidate UE agrees and supports soft switching, for example, the first configuration information includes soft switching parameter configuration information.
(3-3) The source base station or the core network device waits for the first approval information of the candidate UE within the second preset time. For example, the source base station or the core network device waits for the second approval information of the candidate access base station within a preset time.

Once receiving that the first approval information transmitted by a candidate UE satisfies a first switching condition, the candidate UE is immediately selected as a sensing node that performs the first sensing after switching.

Alternatively,

once receiving that the second approval information of a candidate access base station satisfies a first switching condition, the corresponding candidate UE that transmits the first approval information satisfying the first switching condition under the candidate access base station is immediately selected as a sensing node that performs the first sensing after switching.

For example, content of the first approval information includes second configuration information. The second configuration information includes at least one of the following: the same as those of the first configuration information.

In a case that the first request information includes a soft switching request, and the candidate UE agrees and supports soft switching, for example, the second configuration information includes soft switching parameter configuration information.

For the foregoing first switching condition, refer to related description in the implementations described above. Details are not described herein again.

Case two: In a case that the candidate UE disagrees, for example, the candidate UE transmits first rejection information to the first request information transmitting party (the source base station or the core network device).

For example, the candidate access base station transmits second rejection information to the second request information transmitting party (the source base station or the core network device). The second rejection information indicates the second request information transmitting party that the UE accessed by this cell does not perform the second sensing.

In a case that there is no candidate access base station agrees to perform the first sensing within a preset waiting time, subsequent processing may be one of the following: i. the source base station or the core network device redetermines the candidate UE; ii. the candidate access base station redetermines the candidate UE; iii. the source base station or the core network device redetermines the candidate access base station, and the candidate access base station determines the candidate UE; iii. switching is canceled, and current second sensing is maintained; and iv. the current second sensing is ended.

Step 34: The source base station or the core network device transmits, after determining a target UE, switching confirmation information to the target UE. Alternatively, the source base station or the core network device transmits switching confirmation information to the target access base station, and the target access base station transmits the switching confirmation information to the target UE.

For example, the source base station or the core network device transmits, after determining the target UE, switching canceling information to another candidate UE other than the target UE, alternatively, transmits the switching canceling information to another candidate access base station other than the target access base station, and the another candidate access base station forwards the switching canceling information to the another candidate UE. The another candidate UE releases a reserved sensing resource after receiving the switching canceling information.

Step 35: The target UE performs a sensing service, and the source base station releases a sensing resource. Specifically, the following operations are performed:
(35-1) The target UE performs sensing parameter configuration based on at least one of the first request information, the second request information, the first configuration information, and the second configuration information, and performs the first sensing.
(35-2) The source base station or the source base station and UE stop performing the second sensing, and release a sensing resource. According to different sensing nodes before and after switching, one of the following cases is included:
(1) A request information (including the first request information or the second request information) transmitting party is a source base station, and a source UE and a target UE are not the same device.

The source base station transmits a sensing end command to the source UE. The source base station and the source UE end an original sensing operation, and release a resource occupied by sensing (including a time-frequency resource, an antenna port resource, and the like).

For example, the source base station transmits historical measurement values and/or historical sensing results of part or all sensing measurement quantities, and priori information of a sensing target/region to the target UE.

Alternatively, the source base station transmits historical measurement values and/or historical sensing results of part or all sensing measurement quantities, and priori information of a sensing target/region to a target access base station, and the target access base station transmits the historical measurement values and/or the historical sensing results of the sensing measurement quantities, and the priori information of a sensing target/region to the target UE.
(2) A request information (including the first request information or the second request information) transmitting party is a core network device, and a source UE and a target UE are not the same device.

The core network device transmits a sensing end command to the source base station and the source UE. The source base station and the source UE end an original sensing operation, and release a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(3) A request information (including the first request information or the second request information) transmitting party is a core network device, and a source UE and a target UE are the same device.

The core network device transmits a sensing end command to the source base station. The source base station ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(5-3) After obtaining a measurement result and/or a sensing result of at least one sensing measurement quantity, the target UE transmits the measurement result and/or the sensing result of the sensing measurement quantity to the core network device or the source base station. Alternatively,
the target UE transmits the measurement result and/or the sensing result of the sensing measurement quantity to the target access base station, and the target access base station transmits the measurement result and/or the sensing result of the sensing measurement quantity to the core network device or the source base station.

It is to be noted that, in this switching scenario, the sensing measurement quantity before the sensing mode is switched may be the same as or different from the sensing measurement quantity after the sensing mode is switched.

Switching scenario 4: performing a sensing operation by a terminal and a terminal in the second sensing mode is switched to performing a sensing operation by a terminal in the first sensing mode, that is, UE-UE second sensing is switched to UE first sensing. UE A and UE B perform the second sensing before the sensing mode is switched, the UE that transmits a sensing signal is UE A, the UE that receives the sensing signal is UE B, the access base station of the source UE is referred to as a source access base station, the UE that performs the first sensing after switching is referred to as the target UE, and the access base station of the target UE is referred to as the target access base station.

Step 41: Switching measurement is performed.

UE A transmits a switching measurement request to UE B, and UE B performs switching measurement after receiving the switching measurement request and feeds back a switching measurement report to UE A. For example, UE A or UE B transmit the switching measurement report to the source access base station and/or the core network device (for example, the sensing function network element).

Alternatively,
the source access base station transmits a switching measurement request to UE B, and UE B performs switching measurement after receiving the switching measurement request and feeds back a switching measurement report to the source access base station. For example, UE B or the source access base station transmits the switching measurement report to the core network device and/or UE A.

Alternatively,
the core network device (for example, the sensing function network element) transmits a switching measurement request to UE B, and UE B performs switching measurement after receiving the switching measurement request and feeds back a switching measurement report to the core network device. For example, the core network device transmits the switching measurement report to the source access base station and/or UE A.

In some example implementations, before UE B performs switching measurement, any one of UE A, the source access base station, and the core network device transmits switching measurement configuration required for switching measurement to UE B; alternatively, the switching measurement configuration information is included in the switching measurement request.

For the switching measurement configuration information, refer to related description in the implementations described above. Details are not described herein again.

For example, the foregoing step 41 may be triggered based on a triggering event.

The triggering event in the foregoing step 41 may include at least any of the following:
(1) a state of the sensing target changes (the state includes a location, a velocity, and the like);
(2) locations of UE A and/UE B change;
(3) a distance between UE A and UE B changes;
(4) a sensing region environment changes (for example, an obstruction appears);
(5) a sensing measurement quantity obtained by UE B reaches a preset threshold; for example, at least one of a sensing signal received power, a sensing SNR, a sensing SINR, a distance/velocity/angle measurement value, and the like satisfies a preset switching threshold;
(6) a communication measurement quantity obtained by UE B reaches a preset threshold;
(7) a communication measurement quantity between UE A and/or UE B and the source access base station reaches a preset threshold; and
(8) an available sensing resource of UE A and/or UE B changes. For example, in a case that other high-priority sensing/communication/integrated communication and sensing services burst, whether to initiate a sensing switching process needs to be evaluated based on a remaining available sensing resource.

Step 42: The source access base station or the core network device determines whether to initiate switching based on the switching measurement report.

In a case that switching is not initiated, subsequent processing may be maintaining or ending current second sensing.

In a case that switching is initiated, any one of the core network device, the source access base station, and source UEs (including UE A and UE B) determine which node is switched to the first sensing mode, specifically including one of the following cases:

Case 1: The source access base station determines to switch to the UE to perform the first sensing.

The source access base station transmits first request information to at least one candidate UE. Alternatively, the source access base station transmits second request information to at least one access candidate base station. The candidate access base station transmits the first request information to at least one candidate UE.

For example, the source access base station transmits fourth indication information to the core network device.

For example, the candidate UE includes the source UE.

Case 2: The core network device determines to switch to the UE to perform the first sensing mode.

The core network device transmits first request information to at least one candidate UE. Alternatively, the core network device transmits second request information to at least one candidate access base station, and the candidate access base station transmits the first request information to the at least one candidate UE.

For example, the core network device transmits fourth indication information to the source access base station.

The candidate UE includes a source UE, and the candidate access base station includes a source access base station.

Case 3: UE A determines to be actively switched to perform the first sensing. UE A transmits third indication information to the source access base station and/or the core network device. In this case, UE A is a candidate UE.

For example, at least one of UE A, the source access base station, and the core network device transmits second indication information to UE B.

For example, case 3 may further include case 1 or case 2.

Case 4: UE B determines to be actively switched to perform the first sensing. UE B transmits third indication information to the source access base station and/or the core network device. In this case, UE B is a candidate UE.

For example, at least one of UE B, the source access base station, and the core network device transmits second indication information to UE A.

For example, case 4 further includes case 1 or case 2.

For example, the source base station or the core network device includes recommended first configuration information in the first request information and the second request information.

For example, the first request information and the second request information may include a soft switching request.

Step 43: The candidate UE determines whether to perform the first sensing after the sensing mode is switched.

Case one: In a case that the candidate UE agrees, the following processes are performed in sequence:
(43-1) The candidate UE performs sensing parameter configuration based on at least one of the first request information and the first configuration information, and performs the first sensing.
(43-2) After performing at least one sensing measurement, the candidate UE transmits first approval information to the source access base station or the candidate access base station.

Content of the first approval information includes at least one of the following: the same as those in Embodiment 1.

For example, the candidate access base station transmits second approval information to the second request information transmitting party (the source access base station or the core network device).

For example, the second approval information includes part or all content of the first approval information.

For example, the candidate UE feeds back recommended first configuration information in the first approval information.

For the first configuration information, refer to related description in the implementations described above.

In a case that the first request information and the second request information include a soft switching request, and the candidate UE agrees and supports soft switching, for example, the first configuration information includes soft switching parameter configuration information.
(43-3) The source access base station or the core network device waits for the first approval information of the candidate UE within the second preset time. For example, the source access base station or the core network device waits for the second approval information of the candidate access base station within a preset time.

Once receiving that the first approval information transmitted by a candidate UE satisfies a first switching condition, the candidate UE is immediately selected as a sensing node that performs the first sensing after switching.

Alternatively, once receiving that the second approval information of a candidate access base station satisfies a first switching condition, the corresponding candidate UE that transmits the first approval information satisfying the first switching condition under the candidate access base station is immediately selected as a sensing node that performs the first sensing after switching.

For example, content of the first approval information includes second configuration information.

For example, in a case that the first request information includes a soft switching request, and the candidate UE agrees and supports soft switching, the second configuration information includes soft switching parameter configuration information.

For the foregoing first switching condition, refer to related description in the implementations described above.

Case two: In a case that the candidate UE disagrees, for example, the candidate UE transmits first rejection information to the first request information transmitting party (the source access base station or the core network device).

For example, the candidate access base station transmits second rejection information to the second request information transmitting party (the source access base station or the core network device).

In a case that there is no candidate UE agrees to perform the first sensing within the second preset time, subsequent processing may be one of the following: i. the source access base station or the core network device redetermines the candidate UE; ii. the candidate access base station redetermines the candidate UE; iii. the source access base station or the core network device redetermines the candidate access base station, and the candidate access base station determines the candidate UE; iii. switching is canceled, and current second sensing is maintained; and iv. the current second sensing is ended.

Step 4: The source access base station or the core network device transmits, after determining a target UE, switching confirmation information to the target UE; Alternatively, the source access base station or the core network device transmits switching confirmation information to the target access base station, and the target access base station transmits the switching confirmation information to the target UE.

For example, the source access base station or the core network device transmits, after determining the target UE, switching canceling information to another candidate UE other than the target UE; alternatively, transmits the switching canceling information to another candidate access base station other than the target access base station, and the another candidate access base station forwards the switching canceling information to the another candidate UE. The another candidate UE releases a reserved sensing resource after receiving the switching canceling information.

Step 45: The target UE performs a sensing service, and at least one source UE (UE A and/or UE B) releases a sensing resource. Specifically, the following operations are performed:
(45-1) The target UE performs sensing parameter configuration based on at least one of the first request information, the second request information, the first configuration information, and the second configuration information, and performs the first sensing.
(45-2) The source UEs (UE A and/or UE B) stop performing the second sensing, and release a sensing resource. According to different sensing nodes before and after switching, one of the following cases is included:
(1) A request information transmitting party is a source access base station, and a source UE and a target UE are not the same device.

The source access base station transmits a sensing end command to UE A and UE B. UE A and UE B end an original sensing operation, and release a resource occupied by sensing (including a time-frequency resource, an antenna port resource, and the like).

For example, the source access base station transmits historical measurement values and/or historical sensing results of part or all sensing measurement quantities, and priori information of a sensing target/region to the target UE.

Alternatively,
the source access base station transmits historical measurement values and/or historical sensing results of part or all sensing measurement quantities, and priori information of a sensing target/region to a target access base station, and the target access base station transmits the historical measurement values and/or the historical sensing results of part or all sensing measurement quantities, and the priori information of a sensing target/region to the target UE.
(2) A request information transmitting party is a core network device, and a source UE and a target UE are not the same device.

The core network device transmits a sensing end command to UE A and UE B.

UE A and UE B end an original sensing operation, and release a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(3) A request information transmitting party is a source access base station, and UE A and the target UE are the same device.

The source access base station transmits a sensing end command to UE B. UE B ends an original sensing operation, and releases a resource occupied by sensing (including a time-frequency resource, an antenna port resource, and the like).

For example, the source access base station transmits historical measurement values and/or historical sensing results of part or all sensing measurement quantities, and priori information of a sensing target/region to the target UE.
(4) A request information transmitting party is a source access base station, and UE B and target UE are the same device.

The source access base station transmits a sensing end command to UE A. UE A ends an original sensing operation, and releases a resource occupied by sensing (including a time-frequency resource, an antenna port resource, and the like).

For example, the source access base station transmits historical measurement values and/or historical sensing results of part or all sensing measurement quantities, and priori information of a sensing target/region to the target UE.
(5) A request information transmitting party is a core network device, and UE A and a target UE are the same device.

The core network device transmits a sensing end command to UE B. UE B ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(6) A request information transmitting party is a core network device, and UE B and a target UE are the same device:

The core network device transmits a sensing end command to UE A. UE A ends an original sensing operation, and releases a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(5-3) After obtaining a measurement result and/or a sensing result of at least one sensing measurement quantity, the target UE transmits the measurement result and/or the sensing result of the sensing measurement quantity to the core network device or the source base station. Alternatively,

the target UE transmits the measurement result and/or the sensing result of the sensing measurement quantity to the target access base station, and the target access base station transmits the measurement result and/or the sensing result of the sensing measurement quantity to the core network device or the source base station.

It is to be noted that, in this switching scenario, the sensing measurement quantity before the sensing mode is switched may be the same as or different from the sensing measurement quantity after the sensing mode is switched.

Switching scenario 5: performing a sensing operation by a terminal and a terminal in the second sensing mode is switched to performing a sensing operation by a network side device in the first sensing mode, that is, UE-UE second sensing is switched to base station first sensing. UE A and UE B perform the second sensing before the sensing mode is switched, the UE that transmits a sensing signal is UE A, the UE that receives the sensing signal is UE B, UE A and UE B that perform the second sensing before switching are referred to as source UE, an access base station of the source UE is referred to as a source access base station, and a base station that performs the first sensing after switching is referred to a target base station.

Step 51: This step is the same as the foregoing step 41. Details are not described herein again.

Step 52: The source access base station or the core network device determines whether to initiate switching based on the switching measurement report.

In a case that switching is not initiated, subsequent processing may be maintaining or ending current second sensing.

In a case that switching is initiated, the core network device or the source access base station determines which node is switched to the first sensing mode, specifically including one of the following cases:

Case 1: The source access base station determines to switch to the base station to perform the first sensing.

The source access base station transmits first request information to at least one candidate base station.

For example, the source access base station transmits first indication information to the core network device.

For example, the source access base station transmits second indication information to UE A and UE B.

Case 2: The core network device determines to switch to the base station to perform the first sensing mode.

The core network device transmits first request information to at least one candidate base station.

For example, the core network device transmits first indication information to the source access base station.

For example, the core network device transmits second indication information to UE A and/or UE B.

For example, the candidate base station includes the source access base station.

Case 3: The source access base station determines to be actively switched to perform the first sensing. The source access base station transmits third indication information to the core network device. In this case, the source access base station is a candidate base station.

For example, the source access base station and/or the core network device transmits second indication information to the core network device, UE A, and UE B.

For example, case 3 may further include case 1.

For example, the source base station or the core network device includes recommended first configuration information in the first request information.

For example, the first request information may include a soft switching request.

Step 53: The candidate base station determines whether to perform the first sensing after the sensing mode is switched.

Case one: In a case that the candidate base station agrees, the following processes are performed in sequence:
(53-1) The candidate base station performs sensing parameter configuration based on at least one of the first request information and the first configuration information, and performs the first sensing.
(53-2) After at performing least one sensing measurement, the candidate base station transmits first approval information to the source access base station or the core network device.

For content of the foregoing first approval information, refer to related description in the implementations described above. Details are not described herein again.
(53-3) The source access base station or the core network device waits for the first approval information of the candidate base station within a second preset time. Once receiving that the first approval information transmitted by a candidate base station satisfies a first switching condition, the candidate base station is immediately selected as a sensing node that performs the first sensing after switching.

For related content of the foregoing first approval information, refer to related description in the foregoing implementations.

For example, in a case that the first request information includes a soft switching request, and the candidate base station agrees and supports soft switching, the second configuration information includes soft switching parameter configuration information.

For the foregoing first switching condition, refer to related description in the implementations described above.

Case two: In a case that the candidate base station disagrees, for example, the candidate base station transmits first rejection information to the first request information transmitting party (the source access base station or the core network device).

In a case that there is no candidate base station agrees to perform the first sensing within the second preset time, subsequent processing may be one of the following: i. the source access base station or the core network device redetermines the candidate base station; ii. switching is canceled, and current second sensing is maintained; and iii. the current second sensing is ended.

Step 54: The source access base station or the core network device transmits, after determining a target UE, switching confirmation information to the target base station.

For example, the source access base station or the core network device transmits, after determining the target base station, switching canceling information to another candidate base station other than the target base station. The another candidate base station releases a reserved sensing resource after receiving the switching canceling information.

Step 55: The target base station performs a sensing service, and the source UEs (UE A and UE B) release a sensing resource. Specifically, the following operations are performed:
(55-1) The target base station performs sensing parameter configuration based on at least one of the first request information, the first configuration information, and the second configuration information, and performs the first sensing.
(55-2) The source UEs (UE A and UE B) stop performing the second sensing, and release the sensing resource.

The source access base station or the core network device transmits a sensing end command to the source UEs (UE A and UE B). UE A and UE B end an original sensing operation, and release a resource occupied by sensing (including a time-frequency resource, an antenna port resource, and the like).

For example, the source access base station transmits historical measurement values and/or historical sensing results of part or all sensing measurement quantities, and priori information of a sensing target/region to the target base station.
(55-3) After obtaining a measurement result and/or a sensing result of at least one sensing measurement quantity, the target base station transmits the measurement result and/or the sensing result of the sensing measurement quantity to the source access base station or the core network device.

It is to be noted that, in this switching scenario, the sensing measurement quantity before the sensing mode is switched may be the same as or different from the sensing measurement quantity after the sensing mode is switched.

Switching scenario 6: performing a sensing operation by a network side device and a network side device in the second sensing mode is switched to performing a sensing operation by a terminal in the first sensing mode, that is, base station-base station second sensing is switched to UE first sensing. Base station A and base station B perform the second sensing after the sensing mode is switched, the base station that transmits the sensing signal is base station A, the base station that receives the sensing signal is base station B, the UE that performs the first sensing after switching is referred to as target UE, and the access base station of the target UE is referred to as a target access base station.

Step 61: This step is the same as the foregoing step 21. Details are not described herein again.

Step 62: Base station A determines whether to initiate switching based on the switching measurement report.

For example, base station A or base station B reports the switching measurement report to the core network device, and the core network device determines whether to initiate a switching request.

In a case that switching is not initiated, subsequent processing may be maintaining or ending current second sensing.

In a case that switching is initiated, the core network device or the source base stations (including base station A and base station B) determine which node is switched to the first sensing mode, specifically including one of the following cases:

Case 1: Base station A determines to switch to the UE to perform the first sensing. Base station A transmits first request information to at least one candidate UE. Alternatively, base station A transmits second request information to at least one candidate access base station, and the candidate access base station transmits the first request information to the at least one candidate UE.

For example, base station A transmits first indication information to the core network device.

For example, the candidate access base station includes base station B.

Case 2: Base station B determines to switch to the UE to perform the first sensing. Base station B transmits first request information to at least one candidate UE. Alternatively, base station B transmits second request information to at least one candidate access base station, and the candidate access base station transmits the first request information to the at least one candidate UE.

For example, base station B transmits first indication information to the core network device.

For example, the candidate access base station includes base station A.

Case 3: The core network device determines to switch to the UE to perform the first sensing mode. The core network device transmits first request information to at least one candidate UE. Alternatively, the core network device transmits second request information to at least one candidate access base station, and the candidate access base station transmits the first request information to the at least one candidate UE.

For example, the core network device transmits first indication information to base station A and/or base station B.

The candidate access base station includes base station A and base station B.

For example, the source base station or the core network device includes recommended first configuration information in the first request information and the second request information.

For example, the first request information and the second request information may include a soft switching request.

Step 63: The candidate UE determines whether to perform the first sensing after the sensing mode is switched.

Case one: In a case that the candidate UE agrees, the following processes are performed in sequence:
(63-1) The candidate UE performs sensing parameter configuration based on at least one of the first request information and the first configuration information, and performs the first sensing.
(63-2) After performing at least one sensing measurement, the candidate UE transmits first approval information to the source base station or the candidate access base station.

For content of the first approval information, refer to related description in the implementations described above.

For example, the candidate access base station transmits second approval information to the second request information transmitting party (the source base station or the core network device).

For example, the second approval information includes part or all content of the first approval information.

For example, the candidate UE feeds back recommended first configuration information in the first approval information.

For the first configuration information, refer to related description in the implementations described above.

For example, a case that the first request information and the second request information include a soft switching request, and the candidate UE agrees and supports soft switching, the first configuration information includes soft switching parameter configuration information.
(63-3) The source base station or the core network device waits for the first approval information of the candidate UE within the second preset time. For example, the source base station or the core network device waits for the second approval information of the candidate access base station within a preset time.

Once receiving that the first approval information transmitted by a candidate UE satisfies a first switching condition, the candidate UE is immediately selected as a sensing node that performs the first sensing after switching.

Alternatively,
once receiving that the second approval information of a candidate access base station satisfies a first switching condition, the corresponding candidate UE that transmits the first approval information satisfying the first switching condition under the candidate access base station is immediately selected as a sensing node that performs the first sensing after switching.

For example, content of the first approval information includes second configuration information. For the second configuration information, refer to related description in the implementations described above.

For example, in a case that the first request information includes a soft switching request, and the candidate UE agrees and supports soft switching, the second configuration information includes soft switching parameter configuration information.

For the foregoing first switching condition, refer to related description in the implementations described above.

Case two: In a case that the candidate UE disagrees, for example, the candidate UE transmits first rejection information to the first request information transmitting party (the source base station or the core network device).

For example, the candidate access base station transmits second rejection information to the second request information transmitting party (the source base station or the core network device).

In a case that there is no candidate UE agrees to perform the first sensing within a preset waiting time, subsequent processing may be one of the following: i. the source base station or the core network device redetermines the candidate UE; ii. the candidate access base station redetermines the candidate UE; iii. the source base station or the core network device redetermines the candidate access base station, and the candidate access base station determines the candidate UE; iii. switching is canceled, and current second sensing is maintained; and iv. the current second sensing is ended.

Step 64: This step is the same as the foregoing step 34. Details are not described herein again.

Step 65: The target UE performs a sensing service, and the source base station releases a sensing resource. Specifically, the following operations are performed:
(65-1) The target UE performs sensing parameter configuration based on at least one of the first request information, the second request information, the first configuration information, and the second configuration information, and performs the first sensing.
(65-2) The source base stations (base station A and base station B) stop performing the second sensing, and release the sensing resource. According to different sensing nodes before and after switching, one of the following cases is included:
(1) The request information transmitting party is base station A, and base station A and the target base station are not the same device:

base station A transmits a sensing end command to base station B. Base station A and base station B end an original sensing operation, and release a resource occupied by sensing (including a time-frequency resource, an antenna port resource, and the like).

For example, base station A transmits historical measurement values and/or historical sensing results of part or all sensing measurement quantities, and priori information of a sensing target/region to the target UE.

Alternatively,
base station A transmits historical measurement values and/or historical sensing results of part or all sensing measurement quantities, and priori information of a sensing target/region to a target access base station, and the target access base station transmits the historical measurement values and/or the historical sensing results of the sensing measurement quantities, and the priori information of a sensing target/region to the target UE.
(2) The request information transmitting party is base station B, and base station B and the target access base station are not the same device:
base station B transmits a sensing end command to base station A. Base station A and base station B end an original sensing operation, and release a resource occupied by sensing (including a time-frequency resource, an antenna port resource, and the like).

For example, base station B transmits historical measurement values and/or historical sensing results of part or all sensing measurement quantities, and priori information of a sensing target/region to the target UE.

Alternatively,
base station B transmits historical measurement values and/or historical sensing results of part or all sensing measurement quantities, and priori information of a sensing target/region to a target access base station, and the target access base station transmits the historical measurement values and/or the historical sensing results of the sensing measurement quantities, and the priori information of a sensing target/region to the target UE.
(3) A request information transmitting party is the core network device:

The core network device transmits a sensing end command to source base stations (base station A and base station B). Base station A and base station B end an original sensing operation, and release a resource occupied by sensing (including a time-frequency resource, an antenna port resource, and the like).

For example, the core network device transmits historical measurement values and/or historical sensing results of part or all sensing measurement quantities, and priori information of a sensing target/region to the target UE.
(65-3) After obtaining a measurement result and/or a sensing result of at least one sensing measurement quantity, the target UE transmits the measurement result and/or the sensing result of the sensing measurement quantity to the core network device or the source base station. Alternatively,

the target UE transmits the measurement result and/or the sensing result of the sensing measurement quantity to the target access base station, and the target access base station transmits the measurement result and/or the sensing result of the sensing measurement quantity to the core network device or the source base station.

It is to be noted that, in this switching scenario, the sensing measurement quantity before the sensing mode is switched may be the same as or different from the sensing measurement quantity after the sensing mode is switched.

It is to be noted that, the sensing mode switching method according to the implementations of the present disclosure may be performed by a sensing mode switching apparatus, or a control module in the sensing mode switching apparatus for performing the sensing mode switching method. In the implementations of the present disclosure, a sensing mode switching apparatus according to the implementations of the present disclosure is described by taking an example in which the sensing mode switching apparatus performs a sensing mode switching method.

Refer to FIG. 8, which is a structural diagram of a sensing mode switching apparatus according to some implementations of the present disclosure. The sensing mode switching apparatus 800 is applied to a first node. As shown in FIG. 8, the sensing mode switching apparatus 800 includes:
a first obtaining module 801, configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and
a first switching module 802, configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

For example, the first obtaining module 801 is specifically configured to:
obtain a switching measurement report; and
obtain the first sensing measurement result corresponding to each candidate node of the N candidate nodes according to the switching measurement report.

For example, the first obtaining module 801 is specifically configured to:
perform switching measurement to obtain the switching measurement report, where the first node is the signal receiving node that performs a sensing operation on the sensing target in the second sensing mode;
alternatively,
receive the switching measurement report, where the first node includes a core network device or a source transmitting node or a first network side device, the source transmitting node is the signal transmitting node that performs a sensing operation on the sensing target in the second sensing mode, and the first network side device is a network side device accessed by a terminal that performs a sensing operation on the sensing target in the second sensing mode.

For example, a trigger condition for the first node to perform switching measurement includes at least one of the following:
a state of the sensing target changes;
a location of the terminal that performs the sensing operation on the sensing target in the second sensing mode changes;
a sensing region environment of the sensing target changes;
a sensing measurement quantity obtained by the first node satisfies a first condition;
a communication measurement quantity obtained by the first node satisfies a second condition; and
an available sensing resource of at least one sensing node that performs a sensing operation on the sensing target in the second sensing mode changes.

For example, the switching measurement report includes at least one of the following:
a measurement value of at least one sensing measurement quantity;
a measurement value of at least one sensing performance evaluation indicator;
a measurement value of at least one communication measurement quantity;
a measurement value of at least one communication performance evaluation indicator;
indication information used to indicate whether a preset event occurs, where the preset event is used to trigger initiation of switching the sensing mode of the sensing target from the second sensing mode to the first sensing mode; and
indication information used to indicate whether a preset switching condition is satisfied, where the preset switching condition is used to trigger initiation of switching the sensing mode of the sensing target from the second sensing mode to the first sensing mode.

For example, the sensing mode switching apparatus 800 further includes:
a first receiving module, configured to receive at least one of a switching measurement request and switching measurement configuration information before performing switching measurement to obtain the switching measurement report;
alternatively,
a first transmitting module, configured to transmit the switching measurement request before receiving the switching measurement report.

For example, the switching measurement request includes the switching measurement configuration information.

For example, the switching measurement configuration information includes at least one of the following: measurement object indication information, a switching measurement report configuration, measurement event configuration information, and a measurement identifier, where one measurement identifier corresponds to each of one measurement object and one switching measurement report configuration.

For example, the first obtaining module 801 is specifically configured to:
transmit first request information to each candidate node of M candidate nodes, where the first request information is used to request the candidate node to perform a sensing operation on the sensing target in the first sensing mode, and M is a positive integer; and
receive first approval information corresponding to each candidate node of the N candidate nodes, where the N candidate nodes are N candidate nodes of the M candidate nodes, N is less than or equal to M, and the first approval information includes the first sensing measurement result corresponding to the candidate node.

For example, the first request information includes at least one of the following:
first configuration information, where the first configuration information is used for sensing parameter configuration for the candidate node to perform the sensing operation on the sensing target in the first sensing mode;
a sensing demand;
sensing quality of service QoS;
a sensing measurement quantity;
a sensing measurement result;
a sensing condition;
priori information of the sensing target;
priori information of a sensing region of the sensing target; and
a sensing mode switching success determination condition.

For example, the first configuration information includes at least one of the following: sensing parameter configuration information, and soft switching parameter configuration information.

For example, the sensing parameter configuration information includes at least one of the following: a waveform type, a subcarrier spacing, a guard interval, a bandwidth, data burst duration, a time domain interval, signal transmitted power, a signal format, a signal direction, a time resource, a frequency resource, a quasi-co-location QCL relationship, and antenna configuration information.

For example, the first approval information further includes second configuration information, where the second configuration information is used for sensing parameter configuration for the candidate node to perform the sensing operation in the first sensing mode.

For example, the M candidate nodes are determined based on first information of the M candidate nodes, where the first information includes at least one of the following:
location information;
panel orientation information;
sensing capacity information;
current available resource information for sensing; and
channel state information.

For example, the first obtaining module 801 is specifically configured to:
transmit second request information to a second node, where the second request information is used to request the second node to search for a candidate node that performs a sensing operation on the sensing target in the first sensing mode; and
receive second approval information corresponding to each candidate node of the N candidate nodes from the second node, where the second approval information includes the first sensing measurement result corresponding to the candidate node.

For example, the first node is a sensing node that performs a sensing operation on the sensing target in the second sensing mode, and the N candidate nodes include the first node; and
the first obtaining module 801 is specifically configured to:
perform at least one sensing measurement on the sensing target in the first sensing mode to obtain a first sensing measurement result corresponding to the first node.

For example, the sensing mode switching apparatus 800 further includes:
a second transmitting module, configured to transmit first indication information to a third node, where
the first indication information is used to indicate a network side device to perform a sensing operation on the sensing target in the first sensing mode after the sensing mode is switched, one of the first node and the third node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

For example, the sensing mode switching apparatus 800 further includes:
a third transmitting module, configured to transmit second indication information to a fourth node, where
the second indication information is used to indicate the fourth node to perform sensing on the sensing target after the sensing mode is switched, the first node includes a core network device or a first network side device or a second network side device, the first network side device is a network side device accessed by a terminal that performs the sensing operation on the sensing target in the second sensing mode, the second network side device is a network side device that performs the sensing operation on the sensing target in the second sensing mode, and the fourth node is a sensing node that performs the sensing operation on the sensing target in the second sensing mode.

For example, the sensing mode switching apparatus 800 further includes a fourth transmitting module. The fourth transmitting module is specifically configured to:
transmit third indication information to a fifth node, where the third indication information is used to indicate a transmitting party of the third indication information to perform a sensing operation on the sensing target in the first sensing mode after the sensing mode is switched, the first node is a first sensing node that performs the sensing operation on the sensing target in the second sensing mode, and the fifth node includes at least one of a core network device and a second sensing node that performs the sensing operation on the sensing target in the second sensing mode;
alternatively,
receive third indication information from a fifth node, where the third indication information is used to indicate a transmitting party of the third indication information to perform a sensing operation on the sensing target in the first sensing mode after the sensing mode is switched, the first node includes at least one of a first sensing node that performs the sensing operation on the sensing target in the second sensing mode and a core network device, and the fifth node is a second sensing node that performs the sensing operation on the sensing target in the second sensing mode.

For example, the sensing mode switching apparatus 800 further includes:
a fifth transmitting module, configured to transmit fourth indication information to a sixth node.

The fourth indication information is used to indicate a terminal to perform a sensing operation on the sensing target in the first sensing mode after the sensing mode is switched, one of the first node and the sixth node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

For example, the first switching module 802 is specifically configured to:
transmit switching confirmation information to at least one target node, where the target node is a candidate node corresponding to the first sensing measurement result satisfying a first switching condition of the N candidate nodes, and the switching confirmation information is used to notify the target node to perform a sensing operation on the sensing target in the first sensing mode.

For example, the first switching condition includes at least one of the following:
a measurement value of at least one sensing measurement quantity in the first sensing measurement result within a first time period is greater than or equal to a first preset threshold, alternatively, a number of times that a measurement value of at least one sensing measurement quantity in the first sensing measurement result within a first time period is greater than or equal to a first preset threshold reaches a first preset number of times;
a measurement value of at least one sensing measurement quantity in the first sensing measurement result within a second time period is greater than a measurement value of a sensing measurement quantity corresponding to a second sensing measurement result, alternatively, a number of times that a measurement value of at least one sensing measurement quantity in the first sensing measurement result within a second time period is greater than a measurement value of a sensing measurement quantity corresponding to a second sensing measurement result reaches a second preset number of times, and the second sensing measurement result is the first sensing measurement result obtained by performing the sensing operation in the second sensing mode within the first time period;
at least one sensing performance evaluation indicator in the first sensing measurement result within a third time period is greater than or equal to a second preset threshold, alternatively, a number of times that at least one sensing performance evaluation indicator in the first sensing measurement result within a third time period is greater than or equal to a second preset threshold reaches a third preset number of times;
at least one sensing performance evaluation indicator in the first sensing measurement result within a fourth time period is greater than a sensing performance evaluation indicator corresponding to a second sensing measurement result, alternatively, a number of times that at least one sensing performance evaluation indicator in the first sensing measurement result within a fourth time period is greater than a sensing performance evaluation indicator corresponding to a second sensing measurement result within a fourth time period reaches a fourth preset number of times;
a first target value within a first time period is greater than or equal to a first preset threshold, alternatively, a number of times that a first target value within a first time period is greater than a first preset threshold reaches a first preset number of times, and the first target value includes a measurement value of at least one sensing measurement quantity in the first sensing measurement result and a measurement value of at least one communication measurement quantity corresponding to the candidate node;
a second target value within a third time period is greater than or equal to a second preset threshold, alternatively, a number of times that a second target value within a third time period is greater than or equal to a second preset threshold exceeds a third preset number of times, and the second target value includes at least one sensing performance evaluation indicator in the first sensing measurement result and a measurement value of at least one communication measurement quantity corresponding to the candidate node; and
the first sensing measurement result within a fourth time period is superior to the second sensing measurement result.

For example, the at least one target node includes a target terminal; and
the first switching module is specifically configured to:
transmit switching confirmation information to the target terminal through a third network side device, where the third network side device is a network side device accessed by the target terminal.

For example, the sensing mode switching apparatus 800 further includes a sixth transmitting module, which is specifically configured to at least one of the following:
transmit a sensing end command to a seventh node, where the sensing end command is used to indicate a receiving party of the sensing end command to end the sensing operation on the sensing target in the second sensing mode, the seventh node is a sensing node that performs the sensing operation on the sensing target in the second sensing mode, and the seventh node is different from the at least one target node; and
transmit switching canceling information to a first candidate node, where the switching canceling information is used to notify the first candidate node to cancel the sensing operation performed on the sensing target in the first sensing mode and release a reserved sensing resource, and the first candidate node includes a candidate node other than the at least one target node of the N candidate nodes.

For example, the sensing mode switching apparatus 800 further includes:
a first ending module, configured to end performing the sensing operation on the sensing target in the second sensing mode, and release a resource occupied by performing sensing on the sensing target, where the first node is a sensing node that performs the sensing operation on the sensing target in the second sensing mode.

For example, the sensing mode switching apparatus 800 further includes:
a seventh transmitting module, configured to transmit sensing reference information to the at least one target node, where the sensing reference information includes at least one of the following:
a historical measurement value of a sensing measurement quantity of the sensing target;
a historical sensing result of the sensing target;
priori information of the sensing target; and
priori information of a sensing region where the sensing target is located.

For example, the sensing mode switching apparatus 800 further includes:
a first execution module, configured to perform, in a case that the first node does not obtain the first sensing measurement result corresponding to the candidate node within a second preset time, or the first sensing measurement results corresponding to the N candidate nodes do not satisfy a first switching condition, a first operation.

The first operation includes one of the following: redetermining the candidate node, canceling switching the sensing mode of the sensing target from the second sensing mode to the first sensing mode, and ending performing a sensing operation on the sensing target in the second sensing mode.

The sensing mode switching apparatus according to the implementations of the present disclosure may be an electronic device, for example, an electronic device having an operating system, or a part in an electronic device, for example, an integrated circuit or a chip. The electronic device may be a terminal, or may be a network side device. For example, the terminal may include, but is not limited to, types of the terminal 11 listed above. The network side device includes, but is not limited to, types of the network side device 12 listed above. This is not specifically limited in the implementations of the present disclosure.

The sensing mode switching apparatus according to the implementations of the present disclosure can implement various processes implemented by a method embodiment in FIG. 4 and achieve the same technical effects. To avoid repetition, details are not described herein again.

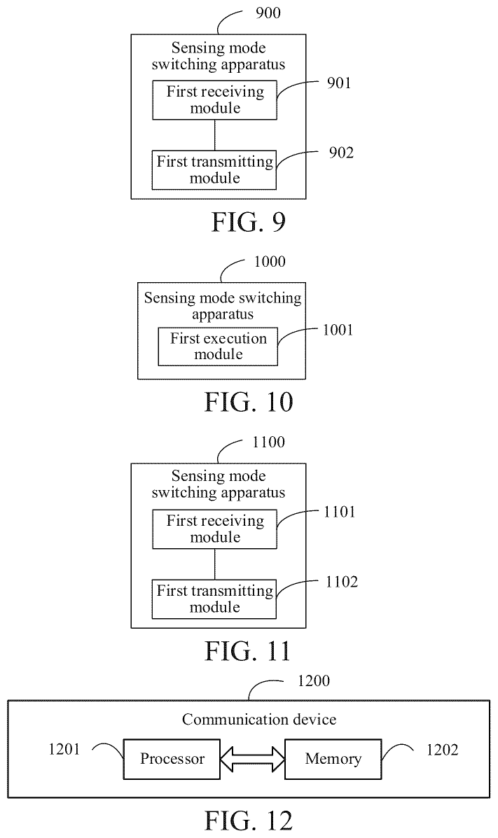

Refer to FIG. 9, which is a structural diagram of a sensing mode switching apparatus according to some implementations of the present disclosure. The sensing mode switching apparatus is applied to a candidate node. As shown in FIG. 9, the sensing mode switching apparatus 900 includes:
a first receiving module 901, configured to receive first request information from a first node, where the first request information is used to request the candidate node to perform a sensing operation on a sensing target in a first sensing mode, and a signal transmitting node of the first sensing mode and a signal receiving node of the first sensing mode are the same node; and
a first transmitting module 902, configured to transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

For example, the sensing mode switching apparatus 900 further includes:
a first configuration module, configured to perform sensing parameter configuration related to the first sensing mode according to the first request information before transmitting the first approval information to the first node; and
a first sensing module, configured to perform at least one sensing measurement on the sensing target in the first sensing mode to obtain a first sensing measurement result.

For example, the first request information includes at least one of the following:
first configuration information, where the first configuration information is used for sensing parameter configuration for the candidate node to perform the sensing operation in the first sensing mode;
a sensing demand;
sensing quality of service QoS;
a sensing measurement quantity;
a sensing measurement result;
a sensing condition;
priori information of the sensing target or priori information of a sensing region where the sensing target is located; and
a sensing mode switching success determination condition.

For example, the first configuration information includes at least one of the following: sensing parameter configuration information, and soft switching parameter configuration information.

For example, the sensing parameter configuration information includes at least one of the following: a waveform type, a subcarrier spacing, a guard interval, a bandwidth, data burst duration, a time domain interval, signal transmitted power, a signal format, a signal direction, a time resource, a frequency resource, a quasi-co-location QCL relationship, and antenna configuration information.

For example, the first approval information further includes second configuration information, where the second configuration information is used for sensing parameter configuration for the candidate node to perform the sensing operation in the first sensing mode.

For example, the sensing mode switching apparatus 900 further includes a second receiving module, which is specifically configured to:
receive switching confirmation information from the first node, where the switching confirmation information is used to notify the candidate node to perform the sensing operation on the sensing target in the first sensing mode after the sensing mode of the sensing target is switched;
alternatively,
receive switching canceling information from the first node, where the switching canceling information is used to notify the candidate node to cancel performing the sensing operation on the first sensing target in the first sensing mode and release a reserved sensing resource.

For example, the sensing mode switching apparatus 900 further includes:
a second configuration module, configured to perform, after receiving switching confirmation information from a first node, sensing parameter configuration related to the first sensing mode according to at least one of the first request information and the second configuration information; and
a second sensing module, configured to perform the sensing operation on the sensing target in the first sensing mode.

For example, the sensing mode switching apparatus 900 further includes:
a second receiving module, configured to receive sensing reference information from the first node after receiving the switching confirmation information from the first node, where the sensing reference information includes at least one of the following:
a historical measurement value of a sensing measurement quantity of the sensing target;
a historical sensing result of the sensing target;
priori information of the sensing target; and
priori information of a sensing region where the sensing target is located.

For example, the candidate node is a sensing node that performs the sensing operation on the sensing target in the second sensing mode before the sensing mode is switched. The sensing mode switching apparatus 900 further includes:
a third receiving module, configured to receive a sensing end command from the first node; and
A first ending module, configured to end performing the sensing operation on the sensing target in the second sensing mode, and release a resource occupied by performing sensing on the sensing target.

The sensing mode switching apparatus according to the implementations of the present disclosure may be an electronic device, for example, an electronic device having an operating system, or a part in an electronic device, for example, an integrated circuit or a chip. The electronic device may be a terminal, or may be a network side device. For example, the terminal may include, but is not limited to, types of the terminal 11 listed above. The network side device includes, but is not limited to, types of the network side device 12 listed above. This is not specifically limited in the implementations of the present disclosure.

The sensing mode switching apparatus according to the implementations of the present disclosure can implement various processes implemented by a method embodiment in FIG. 5 and achieve the same technical effects. To avoid repetition, details are not described herein again.

Refer to FIG. 10, which is a structural diagram of a sensing mode switching apparatus according to some implementations of the present disclosure. The sensing mode switching apparatus is applied to an eighth node. As shown in FIG. 10, the sensing mode switching apparatus 1000 includes:
a first execution module 1001, configured to perform a second operation.

The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

For example, the eighth node is the signal receiving node that performs the sensing operation on the sensing target in the second sensing mode.

The sensing mode switching apparatus 1000 further includes:
a first receiving module, configured to receive second information before transmitting the switching measurement report, where the second information includes at least one of a switching measurement request and switching measurement configuration information; and
a measurement module, configured to perform switching measurement according to the second information to obtain the switching measurement report.

For example, the switching measurement request includes the switching measurement configuration information.

For example, the switching measurement configuration information includes at least one of the following: measurement object indication information, a switching measurement report configuration, measurement event configuration information, and a measurement identifier, where one measurement identifier corresponds to each of one measurement object and one switching measurement report configuration.

For example, sensing nodes that perform the sensing operation on the sensing target in the second sensing mode before the sensing mode is switched include the eighth node and a ninth node.

A triggering condition for the eighth node to perform switching measurement includes at least one of the following:
a state of the sensing target changes;
a sensing region environment of the sensing target changes;
a sensing measurement quantity obtained by the eighth node satisfies a first condition;
a communication measurement quantity obtained by the eighth node satisfies a second condition;
a location of at least one node of the eighth node and the ninth node changes, and at least one of the eighth node and the ninth node is a terminal;
a distance between the eighth node and the ninth node changes, and at least one of the eighth node and the ninth node is a terminal;
a communication measurement quantity between the eighth node and a network side device accessed by the eighth node satisfies a third condition, and the eighth node is a terminal;
a communication measurement quantity between the ninth node and a network side device accessed by the ninth node satisfies a third condition, and the ninth node is a terminal; and
an available sensing resource of at least one of the eighth node and the ninth node changes.

For example, the sensing mode switching apparatus 1000 further includes:
a first ending module, configured to end performing the sensing operation on the sensing target in the second sensing mode after receiving a sensing end command, and release a resource occupied by performing sensing on the sensing target.

The sensing mode switching apparatus according to the implementations of the present disclosure may be an electronic device, for example, an electronic device having an operating system, or a part in an electronic device, for example, an integrated circuit or a chip. The electronic device may be a terminal, or may be a network side device. For example, the terminal may include, but is not limited to, types of the terminal 11 listed above. The network side device includes, but is not limited to, types of the network side device 12 listed above. This is not specifically limited in the implementations of the present disclosure.

The sensing mode switching apparatus according to the implementations of the present disclosure can implement various processes implemented by a method embodiment in FIG. 6 and achieve the same technical effects. To avoid repetition, details are not described herein again.

Refer to FIG. 11, which is a structural diagram of a sensing mode switching apparatus according to some implementations in the present disclosure. The sensing mode switching apparatus is applied to a second node. As shown in FIG. 11, the sensing mode switching apparatus 1100 includes:
a first receiving module 1101, configured to receive second request information transmitted by a first node, where the second request information is used to request the second node to search for a candidate node that performs a sensing operation on a sensing target in a first sensing mode, and a signal transmitting node of the first sensing mode and a signal receiving node of the first sensing mode are the same node; and
a first transmitting module 1102, configured to transmit second response information corresponding to each candidate node of N candidate nodes to the first node, where the second response information includes second approval information or second rejection information, the second approval information includes a first sensing measurement result corresponding to the candidate node, and N is a positive integer.

For example, the sensing mode switching apparatus 1100 further includes:
a second transmitting module, configured to transmit third request information to at least one candidate node before transmitting the second approval information to the first node, where the third request information is used to request the candidate node to perform the sensing operation on the sensing target in the first sensing mode; and
a second receiving module, configured to receive third response information corresponding to each candidate node of K candidate nodes, where the third response information includes third approval information or third rejection information, the third approval information includes a first sensing measurement result corresponding to the candidate node, the second response information corresponding to the N candidate nodes includes part or all of the third response information corresponding to the K candidate nodes, and K is a positive integer greater than or equal to N.

For example, the at least one candidate node is determined based on first information of the at least one candidate node, where the first information includes at least one of the following:
location information;
panel orientation information;
sensing capacity information;
current available resource information for sensing; and
channel state information.

The sensing mode switching apparatus according to the implementations of the present disclosure may be an electronic device, for example, an electronic device having an operating system, or a part in an electronic device, for example, an integrated circuit or a chip. The electronic device may be a network side device, or may be another device other than the network side device. For example, the network side device may include, but is not limited to, types of the terminal 12 listed above. The another device may be a server, a network attached storage (Network Attached Storage, NAS), or the like. This is not specifically limited in the implementations of the present disclosure.

The sensing mode switching apparatus according to the implementations of the present disclosure can implement various processes implemented by a method embodiment in FIG. 7 and achieve the same technical effects. To avoid repetition, details are not described herein again.

For example, as shown in FIG. 12, the implementations of the present disclosure further provide a communication device 1200, including a processor 1201 and a memory 1202. The memory 1202 stores a program or instructions executable on the processor 1201. For example, when the communication device 1200 is a terminal, the program or instructions implement various processes of the implementations of the foregoing sensing mode switching method and achieve the same technical effects when executed by the processor 1201. When the communication device 1200 is a network side device, the program or instructions implement various processes of the implementations of the foregoing sensing mode switching method and achieve the same technical effects when executed by the processor 1201. To avoid repetition, details are not described herein again.

The implementations of the present disclosure further provide a terminal, including a processor and a communication interface. When the terminal is a first node, the processor is configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and the communication interface is configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

Alternatively, when the terminal is a candidate node, the communication interface is configured to: receive first request information from a first node, where the first request information is used to request the candidate node to perform a sensing operation on the sensing target in the first sensing mode, and a signal transmitting node of the first sensing mode and a signal receiving node of the first sensing mode are the same node; and transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

Alternatively, when the terminal is an eighth node, the communication interface is configured to perform a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

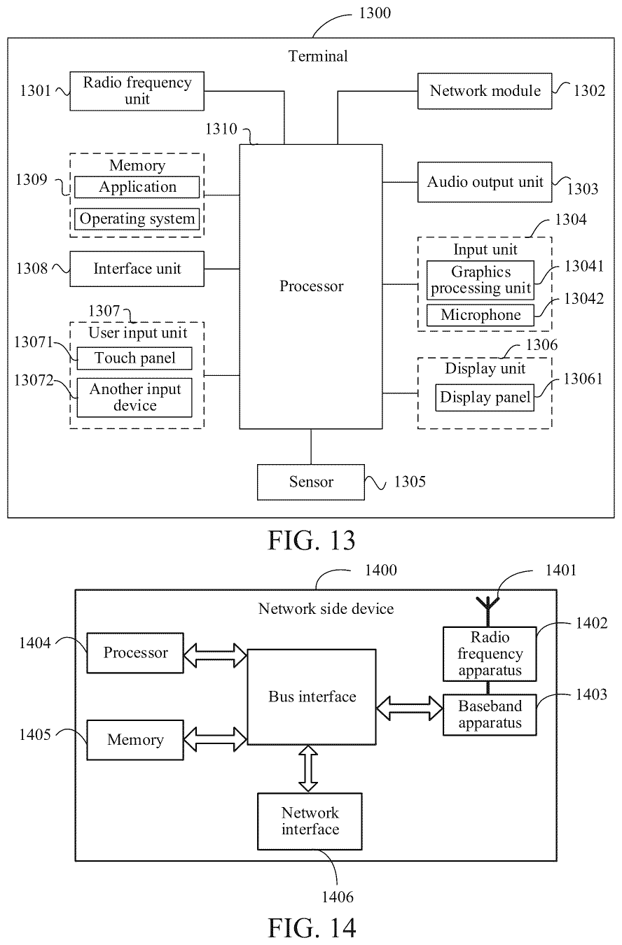

This terminal embodiment corresponds to the foregoing terminal side method embodiment. Various implementation processes and implementations of the foregoing method implementations may be applied to this terminal embodiment and can achieve the same technical effects. Specifically, FIG. 13 is a schematic diagram of a hardware structure of a terminal according to some implementations of the present disclosure.

The terminal 1300 includes, but is not limited to: at least part components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

Those skilled in the art may understand that the terminal 1300 may further include a power supply (for example, a battery) for supplying power to various components. The power supply may be logically connected to the processor 1310 by a power management system, thereby realizing functions such as charging, discharging, and power consumption management by using the power management system. The terminal structure shown in FIG. 13 does not constitute a limitation on the terminal, and the terminal may include more or fewer components than shown, or combine some components, or have different component arrangements. Details are not described herein again.

It is to be understood that, in the implementations of the present disclosure, the input unit 1304 may include a graphics processing unit (Graphics Processing Unit, GPU) 13041 and a microphone 13042. The GPU 13041 performs processing on image data of a static picture or a video obtained by an image acquisition apparatus (for example, a camera) in a video capture mode or an image capture mode. The display unit 1306 may include a display panel 13061. The display panel 13061 may be configured in the form of a liquid crystal display, an organic light-emitting diode, or the like. The user input unit 1307 includes at least one of a touch panel 13071 and another input device 13072. The touch panel 13071 is alternatively referred to as a touchscreen. The touch panel 13071 may include two parts: a touch detection apparatus and a touch controller. The another input device 13072 may include, but is not limited to, a physical keyboard, a functional key (for example, a volume control key or a switch key), a track ball, a mouse, and a joystick. Details are not described herein again.

In the implementations of the present disclosure, after receiving downlink data from a network side device, the radio frequency unit 1301 may transmit the downlink data to the processor 1310 for processing. In addition, the radio frequency unit 1301 may transmit uplink data to the network side device. Generally, the radio frequency unit 1301 includes, but is not limited to, an antenna, an amplifier, a transceiver, a coupler, a low noise amplifier, a duplexer, and the like.

The memory 1309 is configured to store a software program or instructions and various data. The memory 1309 may mainly include a program storage area for storing the program or the instructions and a data storage area for storing the data. The first storage area may store an operating system, an application or instructions required by at least one function (for example, a sound playback function and an image display function), and the like. In addition, the memory 1309 may include a volatile memory or a non-volatile memory, or the memory 1309 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch link DRAM, SLDRAM), or a direct rambus random access memory (Direct Rambus RAM, DR RAM). The memory 1309 in the implementations of the present disclosure includes, but is not limited to, these and any other suitable types of memories.

The processor 1310 may include one or more processing units. For example, the processor 1310 is integrated with an application processor and a modem processor, where the application processor mainly processes operations involving an operating system, a user interface, an application, and the like, and the modem processor mainly processes a wireless communication signal, for example, a baseband processor. It may be understood that, the foregoing modem processor may not be integrated into the processor 1310.

When the terminal 1300 is a first node, the processor 1310 is configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and the radio frequency unit 1301 is configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

Alternatively, when the terminal 1300 is a candidate node, the radio frequency unit 1301 is configured to: receive first request information from a first node, where the first request information is used to request the candidate node to perform a sensing operation on the sensing target in the first sensing mode, and a signal transmitting node of the first sensing mode and a signal receiving node of the first sensing mode are the same node; and transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

Alternatively, when the terminal 1300 is an eighth node, the radio frequency unit 1301 is configured to perform a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

The implementations of the present disclosure further provide a network side device, including a processor and a communication interface. When the network side device is a first node, the processor is configured to obtain a first sensing measurement result corresponding to each candidate node of N candidate nodes, where the first sensing measurement result includes a result obtained by performing at least one sensing measurement on a sensing target in a first sensing mode through the candidate node, a signal transmitting node of the first sensing mode and a signal receiving node of the first sensing mode are the same node, and N is a positive integer; and the communication interface is configured to switch a sensing mode of the sensing target from a second sensing mode to the first sensing mode according to the first sensing measurement result corresponding to each candidate node of the N candidate nodes, where a signal transmitting node of the second sensing mode and a signal receiving node of the second sensing mode are different nodes.

Alternatively, when the network side device is a candidate node, the communication interface is configured to: receive first request information from a first node, where the first request information is used to request the candidate node to perform a sensing operation on the sensing target in the first sensing mode, and a signal transmitting node of the first sensing mode and a signal receiving node of the first sensing mode are the same node; and transmit first response information to the first node, where the first response information includes first approval information or first rejection information, the first approval information includes a first sensing measurement result, the first sensing measurement result includes a result obtained by performing at least one sensing measurement on the sensing target in the first sensing mode through the candidate node, and the first rejection information is used to indicate the candidate node to reject to perform the sensing operation on the sensing target in the first sensing mode.

Alternatively, when the network side device is an eighth node, the communication interface is configured to perform a second operation. The second operation includes at least one of the following:
transmitting a switching measurement report;
receiving first indication information, second indication information, third indication information or fourth indication information, or transmitting third indication information, where the first indication information is used to indicate a network side device to perform a sensing operation on a sensing target in a first sensing mode after the sensing mode is switched, the second indication information is used to perform sensing on the sensing target after the sensing mode is switched, the third indication information is used to indicate a transmitting party of the third indication information to perform the sensing operation on the sensing target in the first sensing mode after the sensing mode is switched, and the fourth indication information is used to indicate a terminal to perform the sensing operation on the sensing target in the first sensing mode after the sensing mode is switched;
transmitting a sensing measurement result, where the sensing measurement result includes a result obtained by performing at least one sensing measurement on the sensing target in the first sensing mode through the eighth node; and
receiving a sensing end command, where the sensing end command is used to indicate a receiving party of the sensing end command to end the sensing operation on the sensing target in a second sensing mode.

A signal transmitting node of the first sensing mode and a signal receiving node of the first sensing mode are the same node, and a signal transmitting node of the second sensing mode and a signal receiving node of the second sensing mode are different nodes.

Alternatively, when the network side device is a second node, the communication interface is configured to: receive second request information transmitted by a first node, where the second request information is used to request a second node to search for a candidate node that performs a sensing operation on a sensing target in a first sensing mode, and a signal transmitting node of the first sensing mode and a signal receiving node of the first sensing mode are the same node; and transmit second response information corresponding to each candidate node of N candidate nodes to the first node, where the second response information includes second approval information or second rejection information, the second approval information includes a first sensing measurement result corresponding to the candidate node, and N is a positive integer.

This network side device embodiment corresponds to the foregoing network side device method implementations. Various implementation processes and implementations of the foregoing method implementations may all be applied to the network side device implementations and can achieve the same technical effects.

Specifically, the implementations of the present disclosure provide a network side device. As shown in FIG. 14, the network side device 1400 includes: an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information through the antenna 1401, and transmits the received information to the baseband apparatus 1403 for processing. In a downlink direction, the baseband apparatus 1403 processes to-be-transmitted information, and transmits processed information to the radio frequency apparatus 1402. The radio frequency apparatus 1402 processes received information and transmits processed information through the antenna 1401.

The method performed by the network side device in the foregoing implementations may be implemented in the baseband apparatus 1403. The baseband apparatus 1403 includes a baseband processor.

The baseband apparatus 1403 may include, for example, at least one baseband board. Multiple chips are arranged on the baseband board. As shown in FIG. 14, a chip is, for example, a baseband processor, and is connected to the memory 1405 through a bus interface to invoke a program in the memory 1405 to perform operations of a network device shown in the foregoing method implementations.

The network side device may further include a network interface 1406. The interface is, for example, a common public radio interface (common public radio interface, CPRI).

Specifically, the network side device 1400 according to the implementations of the present disclosure further includes: instructions or a program stored in the memory 1405 and executable on the processor 1404. The processor 1404 invokes the instructions or the program in the memory 1405 to perform the method performed by various modules shown in any one of FIG. 8 to FIG. 11, and achieves the same technical effects. To avoid repetition, details are not described herein again.

The implementations of the present disclosure further provide a readable storage medium. The readable storage medium stores a program or instructions. The program or the instructions, when executed by a processor, implement various processes of the foregoing sensing mode switching method implementations and achieve the same technical effects. To avoid repetition, details are not described herein again.

The processor is a processor in the terminal in the foregoing implementations. The readable storage medium includes a computer-readable storage medium, such as a computer read-only memory ROM, a random access memory RAM, a magnetic disk, an optical disc, or the like.

The implementations of the present disclosure additionally provide a chip. The chip includes a processor and a communication interface. The communication interface is coupled to the processor. The processor is configured to run a program or instructions to implement various processes of the foregoing sensing mode switching method and can achieve the same technical effects. To avoid repetition, details are not described herein again.

It is to be understood that the chip mentioned in the implementations of the present disclosure may alternatively be referred to as a system-level chip, a system chip, a chip system, a system on a chip, or the like.

The implementations of the present disclosure further provide a computer program/a program product. The computer program/the program product is stored in a storage medium. The computer program/the program product is executed by at least one processor to implement various processes of the foregoing sensing mode switching method and can achieve the same technical effects. To avoid repetition, details are not described herein again.

The implementations of the present disclosure further provide a sensing mode switching system, including: a first node and a candidate node. The first node may be configured to perform various processes of various method implementations at a first node side, the candidate node may be configured to perform various processes of various method implementations at a candidate node side and achieve the same technical effects. To avoid repetition, details are not described herein again.

For example, the foregoing sensing mode switching system further includes: at least one of an eighth node and a second node. The eighth node may be configured to perform various processes of various method implementations at an eighth node side. The second node may be configured to perform various processes of various method implementations at a second node side and can achieve the same technical effects. To avoid repetition, details are not described herein again.

It is to be noted that, terms “include”, “comprise”, or any other variants are intended to cover nonexclusive inclusions, so that a process, a method, an article, or an apparatus including a series of elements not only includes those elements but also includes other elements which are not clearly listed or further includes intrinsic elements of the process, the method, the article, or the apparatus. Without more limitations, elements defined by the sentence “including a” does not exclude that there are still other same elements in the processes, methods, objects, or apparatuses. In addition, it is to be pointed out that the scope of the method and apparatus in the implementations of the present disclosure is not limited to performing functions in the order shown or discussed, and may further include performing functions in a substantially simultaneous manner or in a reverse order according to the functions involved. For example, the described methods may be performed in an order different from the described order, and various steps may be added, omitted, or combined. In addition, features described with reference to some examples may alternatively be combined in other examples.

According to the description of the above implementations, those skilled in the art can clearly understand that the method in the above implementations may be implemented by software in addition to a necessary universal hardware platform or by hardware certainly. In most cases, the former is a more preferred implementation. Based on such an understanding, the technical solutions of the present disclosure essentially or a part thereof that contributes to related arts may be embodied in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods the implementations of the present disclosure.

The implementations of the present disclosure are described above with reference to the accompanying drawings, but the present disclosure is not limited to foregoing specific implementations. The foregoing specific implementations are merely illustrative rather than restrictive. Inspired by the present disclosure, those of ordinary skill in the art may still make multiple forms without departing from the essence of the present disclosure and the scope of protection of the claims, which all fall within the protection of the present disclosure.

What is claimed is:

1. A sensing mode switching method, comprising:
obtaining, by a first node, a first sensing measurement result corresponding to each candidate node of N candidate nodes, wherein the first sensing measurement result comprises a result obtained by performing at least one sensing measurement on a sensing target in a first sensing mode through the candidate node, a signal transmitting node of the first sensing mode and a signal receiving node of the first sensing mode are the same node, and N is a positive integer; and
switching, by the first node, a sensing mode of the sensing target from a second sensing mode to the first sensing mode according to the first sensing measurement result corresponding to each candidate node of the N candidate nodes, wherein a signal transmitting node of the second sensing mode and a signal receiving node of the second sensing mode are different nodes.

2. The method according to claim 1, wherein the obtaining, by a first node, a first sensing measurement result corresponding to each candidate node of N candidate nodes comprises:
obtaining, by the first node, a switching measurement report; and
obtaining, by the first node, the first sensing measurement result corresponding to each candidate node of the N candidate nodes according to the switching measurement report.

3. The method according to claim 2, wherein the obtaining, by the first node, a switching measurement report comprises:
performing, by the first node, switching measurement to obtain the switching measurement report, wherein the first node is the signal receiving node that performs a sensing operation on the sensing target in the second sensing mode; or
receiving, by the first node, the switching measurement report, wherein the first node comprises a core network device or a source transmitting node or a first network side device, the source transmitting node is the signal transmitting node that performs a sensing operation on the sensing target in the second sensing mode, and the first network side device is a network side device accessed by the terminal that performs a sensing operation on the sensing target in the second sensing mode,
wherein a triggering condition for the first node to perform switching measurement comprises at least one of the following:
a state of the sensing target changes;
a location of the terminal that performs the sensing operation on the sensing target in the second sensing mode changes;
a sensing region environment of the sensing target changes;
a sensing measurement quantity obtained by the first node satisfies a first condition;
a communication measurement quantity obtained by the first node satisfies a second condition; or
an available sensing resource of at least one sensing node that performs a sensing operation on the sensing target in the second sensing mode changes,
wherein the switching measurement report comprises at least one of the following:
a measurement value of at least one sensing measurement quantity;
a measurement value of at least one sensing performance evaluation indicator;
a measurement value of at least one communication measurement quantity;
a measurement value of at least one communication performance evaluation indicator;
indication information used to indicate whether a preset event occurs, wherein the preset event is used to trigger initiation of switching the sensing mode of the sensing target from the second sensing mode to the first sensing mode; or
indication information used to indicate whether a preset switching condition is satisfied, wherein the preset switching condition is used to trigger initiation of switching the sensing mode of the sensing target from the second sensing mode to the first sensing mode.

4. The method according to claim 3, wherein before the performing, by the first node, switching measurement to obtain the switching measurement report, the method further comprises:
receiving, by the first node, at least one of a switching measurement request or switching measurement configuration information; or
before the receiving, by the first node, the switching measurement report, the method further comprises:
transmitting, by the first node, a switching measurement request,
wherein the switching measurement configuration information comprises at least one of the following: measurement object indication information, a switching measurement report configuration, measurement event configuration information, or a measurement identifier, wherein one measurement identifier corresponds to each of one measurement object and one switching measurement report configuration.

5. The method according to claim 1, wherein the obtaining, by a first node, a first sensing measurement result corresponding to each candidate node of N candidate nodes comprises:
transmitting, by the first node, first request information to each candidate node of M candidate nodes, wherein the first request information is used to request the candidate node to perform a sensing operation on the sensing target in the first sensing mode; and
receiving, by the first node, first approval information corresponding to each candidate node of the N candidate nodes, wherein the N candidate nodes are N candidate nodes of the M candidate nodes, N is less than or equal to M, and the first approval information comprises the first sensing measurement result corresponding to the candidate node.

6. The method according to claim 5, wherein the first request information comprises at least one of the following:
first configuration information, wherein the first configuration information is used for sensing parameter configuration for the candidate node to perform the sensing operation in the first sensing mode;
a sensing demand;
sensing quality of service QoS;
a sensing measurement quantity;
a sensing measurement result;
a sensing condition;
priori information of the sensing target;
priori information of a sensing region of the sensing target; and
a sensing mode switching success determination condition,
wherein the first configuration information comprises at least one of the following: sensing parameter configuration information, and soft switching parameter configuration information, and
wherein the sensing parameter configuration information comprises at least one of the following: a waveform type, a subcarrier spacing, a guard interval, a bandwidth, data burst duration, a time domain interval, signal transmitted power, a signal format, a signal direction, a time resource, a frequency resource, a quasi-co-location QCL relationship, or antenna configuration information.

7. The method according to claim 5, wherein the first approval information further comprises second configuration information, wherein the second configuration information is used for sensing parameter configuration for the candidate node to perform the sensing operation in the first sensing mode.

8. The method according to claim 5, wherein the M candidate nodes are determined based on first information of the M candidate nodes, wherein the first information comprises at least one of the following:
location information;
panel orientation information;
sensing capacity information;
current available resource information for sensing; or
channel state information.

9. The method according to claim 1, wherein the obtaining, by a first node, a first sensing measurement result corresponding to each candidate node of N candidate nodes comprises:
transmitting, by the first node, second request information to a second node, wherein the second request information is used to request the second node to search for a candidate node that performs a sensing operation on the sensing target in the first sensing mode; and
receiving, by the first node, second approval information corresponding to each candidate node of the N candidate nodes from the second node, wherein the second approval information comprises the first sensing measurement result corresponding to the candidate node.

10. The method according to claim 1, wherein the first node is a sensing node that performs a sensing operation on the sensing target in the second sensing mode, and the N candidate nodes comprise the first node; and
the obtaining, by a first node, a first sensing measurement result corresponding to each candidate node of N candidate nodes comprises:
performing, by the first node, at least one sensing measurement on the sensing target in the first sensing mode to obtain a first sensing measurement result corresponding to the first node.

11. The method according to claim 1, further comprising:
transmitting, by the first node, first indication information to a third node, wherein:
the first indication information is used to indicate a network side device to perform a sensing operation on the sensing target in the first sensing mode after the sensing mode is switched, one of the first node and the third node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

12. The method according to claim 1, further comprising:
transmitting, by the first node, second indication information to a fourth node, wherein:
the second indication information is used to indicate the fourth node to perform sensing on the sensing target after the sensing mode is switched, the first node comprises a core network device or a first network side device or a second network side device, the first network side device is a network side device accessed by a terminal that performs the sensing operation on the sensing target in the second sensing mode, the second network side device is a network side device that performs the sensing operation on the sensing target in the second sensing mode, and the fourth node is a sensing node that performs the sensing operation on the sensing target in the second sensing mode.

13. The method according to claim 1, further comprising:
transmitting, by the first node, third indication information to a fifth node, wherein the third indication information is used to indicate a transmitting party of the third indication information to perform a sensing operation on the sensing target in the first sensing mode after the sensing mode is switched, the first node is a first sensing node that performs the sensing operation on the sensing target in the second sensing mode, and the fifth node comprises at least one of a core network device and a second sensing node that performs the sensing operation on the sensing target in the second sensing mode; or
receiving, by the first node, the third indication information from the fifth node, wherein the third indication information is used to indicate a transmitting party of the third indication information to perform a sensing operation on the sensing target in the first sensing mode after the sensing mode is switched, the first node comprises at least one of a first sensing node that performs the sensing operation on the sensing target in the second sensing mode and a core network device, and the fifth node is a second sensing node that performs the sensing operation on the sensing target in the second sensing mode.

14. The method according to claim 1, further comprising:
transmitting, by the first node, fourth indication information to a sixth node, wherein:
the fourth indication information is used to indicate a terminal to perform a sensing operation on the sensing target in the first sensing mode after the sensing mode is switched, one of the first node and the sixth node is a first network side device or a second network side device, the other is a core network device, the first network side device is a network side device accessed by a terminal that performs the sensing operation on the sensing target in the second sensing mode, and the second network side device is a network side device that performs the sensing operation on the sensing target in the second sensing mode.

15. The method according to claim 1, wherein the switching, by the first node, a sensing mode of the sensing target from a second sensing mode to the first sensing mode according to the first sensing measurement result corresponding to each candidate node of the N candidate nodes comprises:
transmitting, by the first node, switching confirmation information to at least one target node, wherein the target node is a candidate node of the N candidate nodes corresponding to the first sensing measurement result satisfying a first switching condition, and the switching confirmation information is used to notify the target node to perform the sensing operation on the sensing target in the first sensing mode.

16. The method according to claim 15, wherein the first switching condition comprises at least one of the following:
a measurement value of at least one sensing measurement quantity in the first sensing measurement result within a first time period is greater than or equal to a first preset threshold, alternatively, a number of times that a measurement value of at least one sensing measurement quantity in the first sensing measurement result within a first time period is greater than or equal to a first preset threshold reaches a first preset number of times;
a measurement value of at least one sensing measurement quantity in the first sensing measurement result within a second time period is greater than a measurement value of a sensing measurement quantity corresponding to a second sensing measurement result, alternatively, a number of times that a measurement value of at least one sensing measurement quantity in the first sensing measurement result within a second time period is greater than a measurement value of a sensing measurement quantity corresponding to a second sensing measurement result reaches a second preset number of times, and the second sensing measurement result is the first sensing measurement result obtained by performing the sensing operation in the second sensing mode within the first time period;
at least one sensing performance evaluation indicator in the first sensing measurement result within a third time period is greater than or equal to a second preset threshold, alternatively, a number of times that at least one sensing performance evaluation indicator in the first sensing measurement result within a third time period is greater than or equal to a second preset threshold reaches a third preset number of times;
at least one sensing performance evaluation indicator in the first sensing measurement result within a fourth time period is greater than a sensing performance evaluation indicator corresponding to a second sensing measurement result, alternatively, a number of times that at least one sensing performance evaluation indicator in the first sensing measurement result within a fourth time period is greater than a sensing performance evaluation indicator corresponding to a second sensing measurement result within a fourth time period reaches a fourth preset number of times;
a first target value within a first time period is greater than or equal to a first preset threshold, alternatively, a number of times that a first target value within a first time period is greater than a first preset threshold reaches a first preset number of times, and the first target value comprises a measurement value of at least one sensing measurement quantity in the first sensing measurement result and a measurement value of at least one communication measurement quantity corresponding to the candidate node;
a second target value within a third time period is greater than or equal to a second preset threshold, alternatively, a number of times that a second target value within a third time period is greater than or equal to a second preset threshold exceeds a third preset number of times, and the second target value comprises at least one sensing performance evaluation indicator in the first sensing measurement result and a measurement value of at least one communication measurement quantity corresponding to the candidate node; or
the first sensing measurement result within a fourth time period is superior to the second sensing measurement result.

17. The method according to claim 15, wherein the at least one target node comprises a target terminal; and
the transmitting, by the first node, switching confirmation information to at least one target node comprises:
transmitting, by the first node, switching confirmation information to the target terminal through a third network side device, wherein the third network side device is a network side device accessed by the target terminal.

18. The method according to claim 1, further comprising:
when the first node does not obtain the first sensing measurement result corresponding to the candidate node within a second preset time, or the first sensing measurement results corresponding to the N candidate nodes do not satisfy a first switching condition, performing, by the first node, a first operation, wherein:
the first operation comprises one of the following: redetermining the candidate node, canceling switching the sensing mode of the sensing target from the second sensing mode to the first sensing mode, or ending performing a sensing operation on the sensing target in the second sensing mode.

19. A communication device, comprising a processor and a memory, wherein the memory stores a program or instructions executable on the processor, and the program or the instructions, when executed by the processor, implement a sensing mode switching method comprising:
obtaining, by a first node, a first sensing measurement result corresponding to each candidate node of N candidate nodes, wherein the first sensing measurement result comprises a result obtained by performing at least one sensing measurement on a sensing target in a first sensing mode through the candidate node, a signal transmitting node of the first sensing mode and a signal receiving node of the first sensing mode are the same node, and N is a positive integer; and
switching, by the first node, a sensing mode of the sensing target from a second sensing mode to the first sensing mode according to the first sensing measurement result corresponding to each candidate node of the N candidate nodes, wherein a signal transmitting node of the second sensing mode and a signal receiving node of the second sensing mode are different nodes.

20. A non-transitory computer-readable storage medium, wherein the computer-readable storage medium stores a program or instructions, and the program or the instructions, when executed by a processor, implement a sensing mode switching method comprising:
obtaining, by a first node, a first sensing measurement result corresponding to each candidate node of N candidate nodes, wherein the first sensing measurement result comprises a result obtained by performing at least one sensing measurement on a sensing target in a first sensing mode through the candidate node, a signal transmitting node of the first sensing mode and a signal receiving node of the first sensing mode are the same node, and N is a positive integer; and
switching, by the first node, a sensing mode of the sensing target from a second sensing mode to the first sensing mode according to the first sensing measurement result corresponding to each candidate node of the N candidate nodes, wherein a signal transmitting node of the second sensing mode and a signal receiving node of the second sensing mode are different nodes.
